(19) United States
(12) Patent Application Publication
(10) Pub. No.: US 2025/0313413 A1
(43) Pub. Date: Oct. 9, 2025

(54) INTERMEDIATE SURFACE TO SUBSTRATE POWDER TRANSFER SYSTEM AND METHOD

(71) Applicant: Sakuu Corporation, San Jose, CA (US)

(72) Inventors: Karl Littau, Los Altos Hills, CA (US); Denis Shcheglov, Castro Valley, CA (US)

(73) Assignee: Sakuu Corporation, San Jose, CA (US)

(21) Appl. No.: 19/072,702

(22) Filed: Mar. 6, 2025

(51) Int. Cl. B65G 39/02; B05C 19/04; B65G 45/10

(52) U.S. Cl. CPC B65G 39/02; B05C 19/04; B65G 45/10; B65G 2201/042

(57) ABSTRACT

Systems, methods, and other embodiments associated with material deposition. In one embodiment, an apparatus includes an intermediate substrate configured to receive a dry powder, wherein an exterior surface of the intermediate substrate is configured to move and enclose a volume, the intermediate substrate positioned above a target substrate. The example apparatus may also include a powder distribution device configured to distribute the dry powder on the exterior surface of the intermediate substrate, then direct energy from a directed energy device to the intermediate substrate to disrupt an adhesion of an adhered layer of the dry powder along a moving portion of the exterior surface of the intermediate substrate positioned vertically above the target substrate to facilitate transfer of a volume of the dry powder from the intermediate substrate to the target substrate thereby forming a powder layer on the target substrate.

### TECHNICAL FIELD

The embodiments generally relate to material deposition in powder deposition systems and material or powder patterning systems that can include powder printing systems, 3D printing systems, and additive manufacturing machines and systems. In particular, the embodiments generally relate to apparatus, methods, and systems for transferring material such as powder from an intermediate substrate (e.g., a rotating surface or body) to a target substrate (e.g., a conveyed substrate).

### BACKGROUND

The direct deposition of a uniform dry patterned powder onto a substrate can reduce the need for additional powder processing for manufacturing a product. Generally, precise control and high-speed deposition of dry powder, particularly patterned powder can be challenging using current material dispensers found in powder printing systems, 3D Printing systems, and additive manufacturing machines and systems. One problem with current material dispensers, as implemented with conveyed substrates, involves the use of a hopper or a feeder which dispenses material such as dry powder as a nonuniform powder pile. The hopper dispenses the dry powder as a pile onto the substrate that may then require further smoothing and conditioning to obtain a uniform and smooth surface. Once the powder surface is smoothed out and uniform on the substrate it may then be patterned. In order to improve deposition speed and powder surface uniformity, the hopper/feeder surface geometries, surface coating, agitation, and dispensing mechanism may be adjusted to obtain a consistent powder mass flow rate for the powder pile. However, the powder can often still require further smoothing and conditioning to obtain a uniform powder layer for patterning and compaction at a calender stage. Another problem with the above material dispenser includes the lack of precise control of powder deposited at high speeds as it is mechanically agitated/actuated to be transferred onto the substrate which tends to result in non-uniform powder deposition. Further, while consistent powder mass flow rate is desirable and can aide in downstream powder processing such as smoothing and compaction of the dry powder, the lack of depositing patternable powder can limit the shape, features, feature sizes, and other qualities of the deposited powder. A problem with material dispensers, as implemented with build platforms (e.g., powder bed systems or binder jetting 3D printing system), involves the use of a sprayer or nozzle to deposit powder particles which tend to have larger particle sizes leading to thick layers and rough surfaces, which limits the feature sizes and printing resolution and may also create large voids which prevent full densification during sintering processes. Moreover, the process of depositing a layer, patterning the layer with binder, and curing the binder can be a slow and time-consuming process for manufacturing a product. Therefore, there is a need for a dry powder printing system and method that can provide precise control, uniformity, feature size, speed, shapes, and other qualities for depositing a patterned powder.

### SUMMARY

In an implementation, an apparatus including an intermediate substrate configured to receive a dry powder, wherein an exterior surface of the intermediate substrate is configured to move and enclose a volume, the intermediate substrate positioned above a target substrate; a powder distribution device, the powder distribution device configured to distribute the dry powder on the exterior surface of the intermediate substrate; and a directed energy device, the directed energy device configured to apply energy to the intermediate substrate to disrupt the adhesion of an adhered layer of the dry powder along a moving portion of the exterior surface of the intermediate substrate positioned vertically above the target substrate; and wherein disruption of the adhesion of the adhered layer positioned on the exterior surface of the intermediate substrate facilitates transfer of a volume of the dry powder from the intermediate substrate to the target substrate thereby forming a powder layer on the target substrate.

In another implementation, a method including positioning an intermediate substrate configured to receive a dry powder above a target substrate, the intermediate substrate having an exterior surface configured to move and enclose a volume; depositing the dry powder onto the exterior surface of the intermediate substrate to form an adhered layer; directing energy to the intermediate substrate to disrupt the adhesion of the adhered layer along a moving portion of the exterior surface of the intermediate substrate positioned vertically above the target substrate; and transferring a volume of the dry powder of the adhered layer disrupted by the directed energy onto the target substrate, the transferred volume of the dry powder forming a powder layer on the target substrate.

### BRIEF DESCRIPTION OF THE DRAWINGS

The accompanying drawings, which are incorporated in and constitute a part of the specification, illustrate various systems, apparatus, methods, and one or more implementations of the disclosure. It will be appreciated that the illustrated element boundaries (e.g., boxes, groups of boxes, or other shapes) in the figures represent one implementation of the boundaries. In some implementations one element may be implemented as multiple elements or that multiple elements may be implemented as one element. In some implementations, an element shown as an internal component of another element may be implemented as an external component and vice versa. Furthermore, elements may not be drawn to scale. The drawing figures depict one or more implementations in accord with the present teachings, by way of example only, not by way of limitation. It is to be understood that the drawings are designed for the purpose of illustration only and not as a definition of the limits of the present disclosure. In the figures, like reference numerals refer to the same or similar elements. Furthermore, it should be understood that the drawings are not necessarily to scale. A complete understanding of the present implementations and the advantages and features thereof will be more readily understood by reference to the following detailed description when considered in conjunction with the accompanying drawings wherein:

FIG. 1 illustrates one embodiment of a powder transfer system for direct deposition of patterned powder and precise control of powder feature size, shape, and uniformity while improving powder deposition speed, in accordance with aspects of the present disclosure;

FIG. 2A illustrates an exploded view of one embodiment of a directed energy system for applying directed energy to a portion of the intermediate substrate of the powder transfer system of FIG. 1, in accordance with aspects of the present disclosure;

FIG. 2B illustrates an example process to facilitate adherence and removal of powder on the exterior surface of the intermediate substrate of the powder transfer system of FIG. 2A, in accordance with aspects of the present disclosure;

FIG. 2C illustrates an example process to facilitate adherence and removal of powder on the exterior surface of the intermediate substrate of the powder transfer system of FIG. 2A, in accordance with aspects of the present disclosure;

FIG. 2D illustrates an example powder volume transfer after processing of a volume of powder adhered to the exterior surface of the intermediate substrate of the powder transfer system of FIG. 2A, in accordance with aspects of the present disclosure;

FIG. 2E illustrates an example powder layer formed by the powder volume transfer of the directed energy system of FIG. 2A, in accordance with aspects of the present disclosure;

FIGS. 3A-3D illustrate examples of an exterior surface of the intermediate substrate of the powder transfer system of FIG. 2A, in accordance with aspects of the present disclosure;

FIG. 4 illustrates one embodiment of a powder transfer system for direct deposition of patterned powder and precise control of powder feature size, shape, and uniformity while improving powder deposition speed, in accordance with aspects of the present disclosure;

FIG. 5A illustrates one embodiment of a powder transfer system for direct deposition of patterned powder and precise control of powder feature size, shape, and uniformity while improving powder deposition speed, in accordance with aspects of the present disclosure;

FIG. 5B illustrates one embodiment of a powder transfer system for direct deposition of patterned powder and precise control of powder feature size, shape, and uniformity while improving powder deposition speed, in accordance with aspects of the present disclosure; and

FIG. 6 illustrates one embodiment of a flowchart depicting a process for facilitating direct deposition of patterned powder and precise control of powder feature size, shape, and uniformity while improving powder deposition speed, in accordance with aspects of the present disclosure.

### DETAILED DESCRIPTION

Systems and methods are described herein as associated with a powder transfer system and method for providing direct deposition of patterned powder and precise control of powder feature size, shape, uniformity, improved powder deposition speed, and other qualities and features as described herein for depositing a patterned powder. Current powder deposition systems and methods for battery manufacturing include a powder bed system and a conveyor/roll system can often lead to nonuniform powder deposition and lack of precise control of powder feature sizes, shapes, uniformity, improved powder deposition speed, and other qualities. For example, in the powder bed system (i.e., binder jetting 3D printing system), powder is deposited and processed in-situ using a build platform. The powder deposition in powder bed systems typically involves the use of a sprayer or nozzle to deposit powder particles layer by layer on the build platform. The particles deposited using a sprayer or a nozzle tend to have larger particle sizes leading to thick layers and rough surfaces, which limits the feature sizes and printing resolution and may also create large voids which prevent full densification during sintering processes. Moreover, the process of depositing a layer, patterning the layer with binder, and curing the binder can be a slow and time-consuming process for manufacturing a product. As another example, the powder deposition in conveyor/roll systems typically involves the use of a hopper or a feeder which dispenses material such as dry powder as a nonuniform powder pile. In order to improve deposition speed and powder surface uniformity, the hopper/feeder surface geometries, surface coating, agitation, and dispensing mechanism may be adjusted to obtain a consistent powder mass flow rate for the powder pile. However, the powder can often still require further smoothing and conditioning to obtain a uniform powder layer for patterning and compaction at a calender stage. Further, the material dispenser can lack precise control of powder deposited at high speeds as powder is mechanically agitated/actuated to be transferred onto the substrate which tends to result in non-uniform powder deposition.

The present disclosure solves these problems and others using a powder transfer system having an intermediate surface to receive dry powder temporarily and a target substrate to receive the dry powder from the intermediate substrate. The powder may be deposited as a patterned powder onto the intermediate surface. The dry powder may be received onto the intermediate surface and transported to a target substrate using a directed energy system. The directed energy may be spatially and temporally modulated thereby transporting a patterned powder layer to the target substrate. Moreover, the dry powder may also be conditioned or treated on the intermediate surface as needed. The intermediate surface may be cleaned and pre-/post-conditioned prior to receiving dry powder for transfer to the target substrate. The intermediate surface may be coated or conditioned/treated to facilitate adhesion of dry powder to the intermediate surface. The powder may be conditioned/treated while adhered to the intermediate surface to facilitate adhesion and/or cohesiveness of the dry powder. Other benefits and advantages of the powder transfer system are described herein.

### Powder Transfer Apparatus

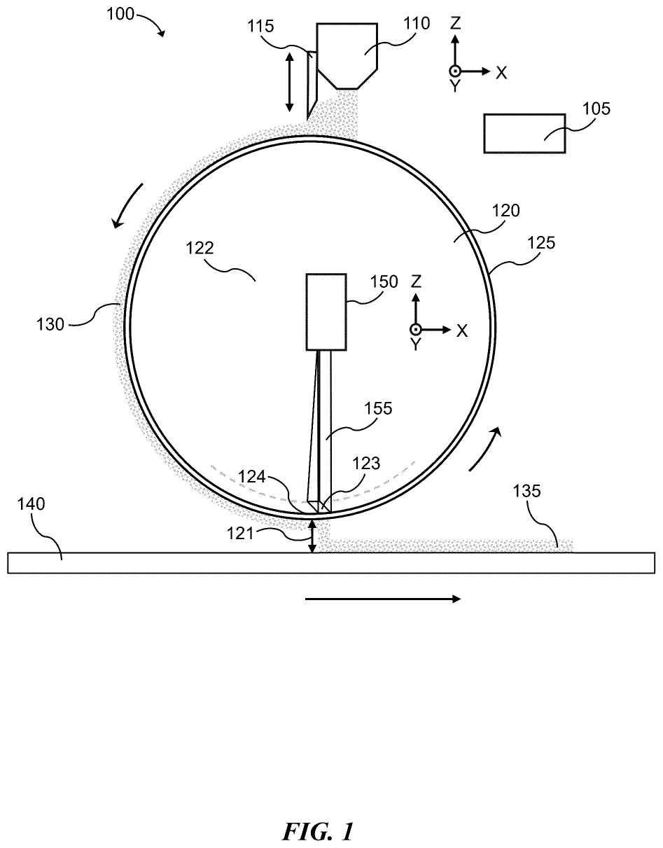

With reference to FIG. 1, one implementation of a powder transfer system is illustrated, the powder transfer system being configured for direct deposition of patterned powder and precise control of powder feature size, shape, and uniformity while improving powder deposition speed onto a conveyor or continuous substrate. In various embodiments and examples described herein, powder is disposed onto a moving intermediate surface that facilitates transfer of the powder from the intermediate surface to a target surface or substrate. Further, in many implementations, pre-conditioning and post-conditioning of the powder and the intermediate surface may facilitate increased powder mass flow (i.e., powder volume transfer), uniform powder deposition onto a target surface, and minimized contamination of the powder and the intermediate surface. An object of the disclosure is to transfer, in selected areas, all of the powder disposed onto the moving intermediate surface without modifying the microstructure, rheological properties, and flowability of the deposited powder. In other words, the structure, form, and properties of the powder are not changed to facilitate powder transfer from the intermediate surface to the target surface. In some embodiments, the applied energy from the directed energy source is minimal such that the rheological properties of the powder particles are unchanged or substantially the same (i.e., minimally changed) such that the particles within the volume of dry powder do not fuse together, deform, or become damaged. Moreover, the applied energy may be minimally applied (pulsed or intermittently applied) to dislodge or disrupt an adhesion of the dry powder particle surface to the surface of the exterior surface of the intermediate substrate. In some implementations, the applied energy may be minimally applied to remove a portion of a surface of particle(s) of the powder adhered to the exterior surface of the intermediate substrate to remove adhesion of a volume of powder and facilitate transport of the volume of powder to a target substrate. A further object of the disclosure is to pre-condition the powder and intermediate surface as needed in order to improve the speed and quality of transfer of the volume of powder from the intermediate surface to the target surface. Another object of the disclosure is to facilitate patterned transfer of powder (e.g., using directed energy) from the intermediate substrate to the target substrate. Another object of the disclosure is to facilitate waterfall powder transfer from the intermediate surface to the target surface whereby powder on the intermediate surface is continually transferred from a moving intermediate surface to a moving target surface. A further object of the disclosure is to facilitate higher speed and precision for direct powder deposition from a funnel or hopper onto a target substrate through the use of an intermediate surface and pre-conditioning and post-conditioning devices as needed. These and other aspects and benefits can be readily appreciated and will be described in some of the embodiments of the disclosure herein.

FIG. 1 illustrates an aspect and embodiment in which a powder transfer system 100 is configured to include a controller 105, a hopper or funnel 110 to dispense powder 130 onto an exterior surface 125 of an intermediate substrate 120 (e.g., a rotating body), a smoothing blade 115, a directed energy device 150 to direct energy 155 onto an interior surface 124 beneath the exterior surface 125 of the intermediate substrate 120. The directed energy device 150 may be used to apply directed energy 155 on one or more transfer regions 123 along the exterior surface 125 to transfer powder 130 onto a substrate 140. The transfer region 123 may include one or more regions or areas along the lower or lowest portions of the intermediate substrate 120 vertically above a substrate 140. The directed energy 155 may be directed to a single transfer region 123 (e.g., one or more strips or polygonal areas), the transfer region 123 may be further configured through additional conditioning means or units as described herein to facilitate transfer of the powder 130 to the substrate 140 opposite the exterior surface 125. Further, the transfer region 123 may be defined as desired to facilitate transfer of a predetermined area and volume of powder 130 in proximity to, or on, the transfer region 123.

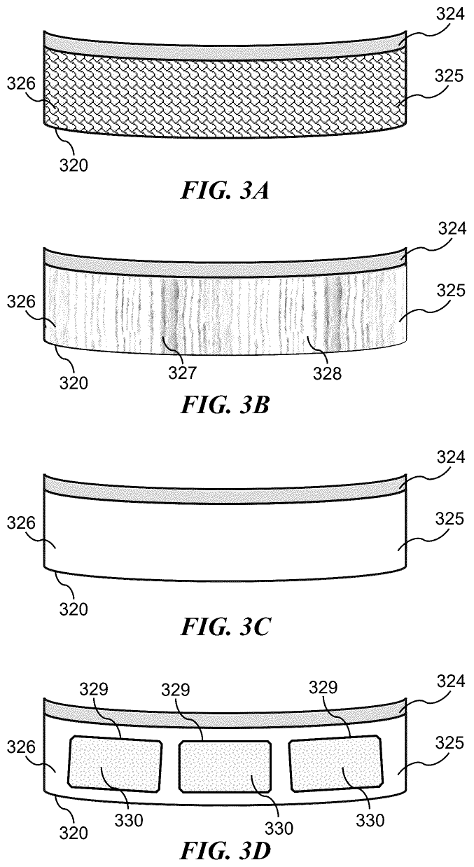

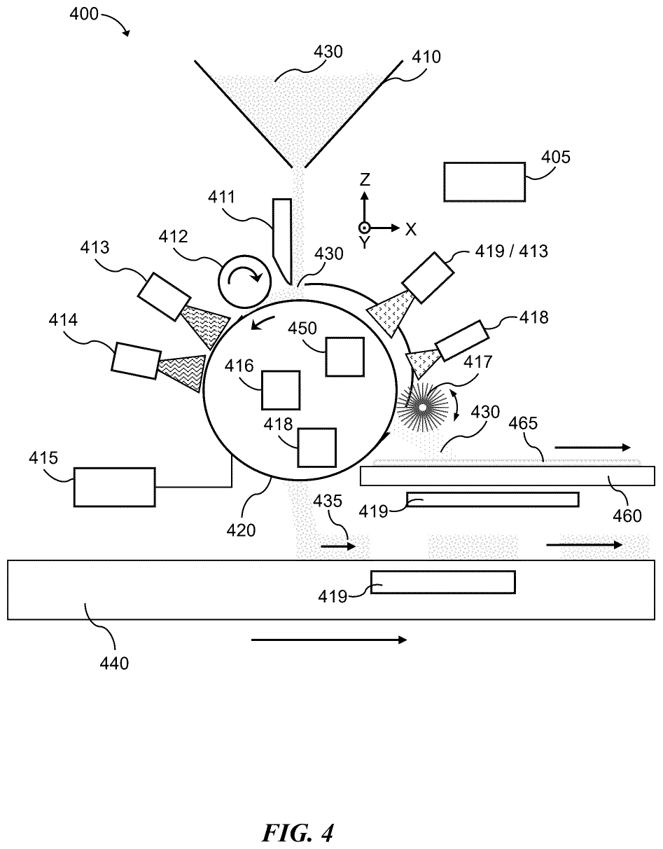

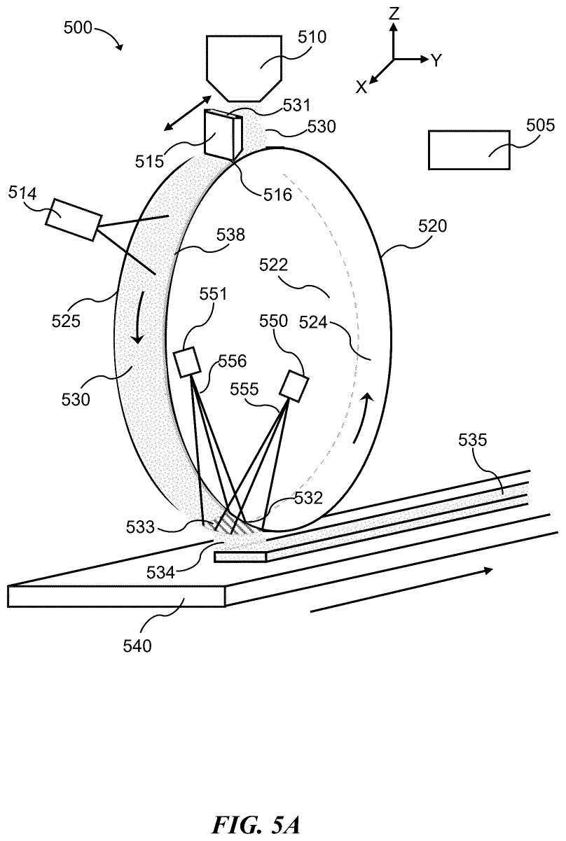

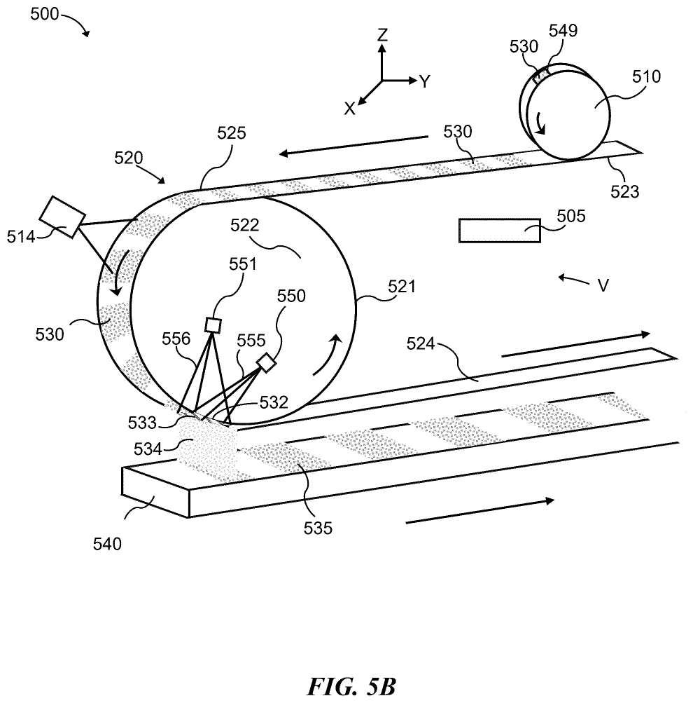

The powder 130 may be transferred from the exterior surface 125 of the intermediate substrate 120 onto a substrate 140 intermittently or continuously, for example. The dispensed powder 130 may be any flowable powder or particle, for example, loose dry powder. The intermediate substrate 120 and substrate 140 may be vertically spaced apart by a gap 121 to facilitate speed, precision, and uniformity of powder transfer (i.e., volume of powder transferred) as a powder layer 135 onto substrate 140. In various implementations, the height of the gap 121 may be defined in a range from 0.01 mm to 10.00 mm. In one embodiment, the height of the gap 121 may be defined with a preferable range from 0.05 mm to 2 mm. In some implementations, the substrate 140 may be a segmented substrate, an individual substrate or carrier plate, a flexible substrate, or a continuous or conveyed substrate (e.g., roll-to-roll substrate/processing). In various implementations, the powder transfer system 100 can facilitate continuous transfer of powder 130 onto a moving substrate 140. The powder 130 may be formed as a continuous layer(s), shape(s), or strip(s) of powder, a separate shape(s) or strip(s) of powder, or a patterned layer or shape transferred onto the moving substrate 140 as a smooth and substantially uniform powder layer 135. The powder 130 may be formed of any arbitrary size or shape, patterned or non-patterned, on the intermediate substrate 120. In some implementations, the intermediate substrate 120 may include one or more stencils to receive powder 130 (as shown in FIG. 3D). The powder 130 deposited into the stencil may then be smoothed out by a blade (as shown in FIGS. 1 and 5A) to facilitate transfer of powder 130 in any pattern/shape as desired. The powder 130 may be deposited on the intermediate substrate 120 may be formed and/or patterned using a stencil of any shape, for example, dots, strips, triangles, rectangles, squares, or any desired polygonal shape, and thereafter transferred as a patterned shape or layer onto the moving substrate 140. In one embodiment, powder 130 on intermediate substrate 120 may be patterned using blade 115, additional directed energy sources, one or more conditioning devices (as shown in FIG. 4), or any combinations thereof. For example, a conditioning device (e.g., a blade) may be positioned between funnel 110 and the transfer region of powder 130. In particular, the conditioning device may be positioned within or adjacent to a portion of the volume enclosed by the movement of the exterior surface of the intermediate substrate (as shown in FIGS. 4 and 5A-5B). The conditioning device may be used to displace powder 130 received on the intermediate substate by, for example, an additional blade may be implemented to divide the powder 130 dispensed on the intermediate substrate. Moreover, the directed energy device 150 is not limited to being positioned inside or within the intermediate substrate. In certain embodiments, one or more directed energy devices 150 may be implemented and positioned inside and/or outside of the intermediate substrate 120. As long as the directed energy 155, when applied to a portion of the powder 130 and/or an exterior/interior surface of the intermediate substrate 120, does not change the powder properties of the volume of powder transferred to the target surface/substrate.

In a further aspect of the disclosure, the funnel 110 may be configured to move along a longitudinal direction (or a tangential direction, in the case of a rotating body comprising an intermediate substrate), horizontal to the volume enclosed by the movement of the exterior surface of the intermediate substrate 120 (X-direction), along a direction vertical to the movement of the intermediate substrate 120 (Z-direction), and along a direction lateral or axial to the movement of the intermediate substrate 120 (Y-direction). The funnel 110 may be configured to dispense loose or flowable powder onto the intermediate substrate 120. Some examples of powder compositions, powder engineering, and funnel configurations that may be utilized by the apparatus and method of the present disclosure are described in a related application by the Applicant (U.S. application Ser. No. 18/966,015), entitled “Powder Distribution System and Method,” filed on Dec. 10, 2024, and which is hereby incorporated by reference. The related application describes an apparatus that includes a funnel configured for storing, transporting, and maintaining the flowability and cohesiveness of powder. The related application further describes methods for powder engineering and maintaining the flowability and cohesiveness of the powder contained in the funnel. In some embodiments, the funnel 110 may further include a smoothing blade 115 configured to be fixed and stationary on the funnel 110. In certain implementations, the smoothing blade 115 may be configured to be movable attached, or slidably attached to an exterior surface of the funnel 110. In some implementations, the smoothing blade 115 may be configured to be separate from the funnel 110 and stationary or movable above the exterior surface 125 of the intermediate substrate 120. In some implementations, the smoothing blade 115 may be replaced with a counter-rotating roller, squeegee, or other smoothing apparatus.

In a further aspect of the disclosure, the intermediate substrate 120 is positioned below the funnel 110 and configured to receive the dispensed powder 130 from the funnel 110. In many embodiments, the intermediate substrate 120 of the powder transfer system 100 facilitates collection of dispensed material on an intermediate surface and continuous and direct transfer of the dispensed material onto a target surface. The dispensed powder 130 can adhere to the intermediate substrate 120 without aid, through several means including, for example, cohesiveness of the powder, surface features/quality of the intermediate substrate 120, and electrostatic attraction of the powder 130 to the exterior surface 125 of the intermediate substrate 120. In certain implementations, the intermediate surface and/or material may be pre-conditioned and/or subjected to further processing or conditioning as described herein to effectuate precise and high-speed direct transfer of the dispensed material onto the target surface. Further, in many implementations, the powder 130 may be transferred to the substrate 140 by removing the adherence of the powder 130 to the exterior surface 125 of the intermediate substrate 120. Moreover, as described herein, the adherence of the powder 130 may be removed and the powder 130 transferred without modifying the microstructure, rheological properties, flowability and cohesiveness of the deposited material (e.g., loose dry powder). The powder microstructure may include physical and structural characteristics of powder particles at microscopic levels such as size, shape and morphology, distribution, porosity, surface area, crystallinity, agglomeration, cohesion, and conductivity. The microstructure of battery powders can significantly influence battery electrode performance, conductivity, ion transport, electrode stability, durability, and efficiency. Various apparatuses and processes are described herein to allow precise control over powder transfer without fusing powder particles or chemically or physically changing the powder composition and microstructure to any significant extent.

The present disclosure facilitates transfer of powder particles enabling dry powder printing (i.e., patternable powder deposition) with high performance-speed, feature size, precision, uniformity, and other qualities while eliminating or minimizing chemical or physical methods that can change the microstructure of powder particles such as, for example, high temperatures, pressures, additives, and doping elements. The powder particles may include, for example, spherical or substantially spherical particles, particles of carbon black, graphene, or CNTs (carbon nanotubes), and other active, conductive, or binder materials and particles as is known in the art. As an example, in some implementations, the powder transfer system can facilitate transfer of a certain particle size distribution of powder engineered to enhance cohesion by reducing the median particle size to less than 50 um and preferably less than 20 um. Further, adjusting the powder to include at least 1% of fine particles with a diameter of less than 10 um and preferably less than 5 um may also be useful to enhance the cohesion. In addition, adjusting the surface coating on the powder particles can enhance the cohesion of the powder by enhancing the attractive interaction between the particles.

In some configurations, directed energy 155 may be applied to one or more transfer regions 123 beneath the powder 130 to remove adherence of the powder 130 to the exterior surface 125. The transfer regions 123 may be of arbitrary size and shape limited only by the minimum size of the directed energy spot, area, or size thereby facilitating digital control of powder transfer. Subsequently, the powder 130 on the exterior surface 125 of the intermediate substrate 120 within the transfer region 123, along the boundaries of the transfer region 123, or in proximity to the boundaries of the transfer region 123 is transferred to the substrate 140. Further, in certain implementations one or more transfer regions 123 can be configured and positioned as a region vertically above (or directly above) a portion of a moving substrate 140 such that the powder 130 separated from the intermediate substrate 120 can be directly transferred to the moving substrate 140 below in a waterfall powder transfer. Moreover, in some implementations, one or more transfer regions 123 applied with directed energy 155 may be positioned to include one or more portions of the exterior surface 125 adjacent to where powder 130 was transferred or where the adherence of the powder 130 was removed. As an example, various materials for the intermediate substrate 120 and applications of direct energy 155 are described herein and should not be construed as limiting, other applications of directed energy, for example, application of mechanical, acoustic, or any electromagnetic pulsed or continuous energy may be readily contemplated to facilitate transfer of the powder 130 from the exterior surface 125 to the substrate 140. Moreover, one or more combination of direct energy sources and/or configuration of direct energy sources (e.g., energy level, pulse frequency, positioning, etc.,) may be readily contemplated to facilitate transfer of the powder 130 from the exterior surface 125 to the substrate 140.

In some implementations, the material of the intermediate substrate 120 and type of directed energy device 150 may be selected and configured such that the directed energy 155 substantially heats an inner surface of the intermediate substrate 120 to minimize changes in the powder microstructure. In some embodiments, the inner surface of the intermediate substrate 120 may be a material surface or material layer(s) forming the top/upper surface of the interior surface 124. In some embodiments, the inner surface of the intermediate substrate 120 may be a material surface or material layer(s) adjacent to the top/upper surface of the interior surface 124. The directed energy 155 may gradually impart (e.g., indirectly apply) energy to the powder 130 at an interface between the powder 130 and the exterior surface 125 and facilitate separation of the powder 130 from the exterior surface 125. In some implementation, the material of the intermediate substrate 120 and type of directed device 150 may be selected and configured such that the directed energy 155 substantially heats an outer surface of the intermediate substrate 120 to rapidly impart (e.g., directly apply) energy to the powder 130 at an interface between the powder 130 and the exterior surface 125. In some embodiments, the outer surface of the intermediate substrate 120 may be a material surface or material layer(s) forming the top/upper surface of the exterior surface 125. In some embodiments, the outer surface of the intermediate substrate 120 may be a material surface or material layer(s) adjacent to the top/upper surface of the exterior surface 125. In one implementation, the directed energy 155 may be applied to the exterior surface 125 without changing the powder microstructure or vaporizing the powder 130 to separate the powder 130 from the exterior surface 125.

In some implementations, the outer surface of intermediate substrate 120 may be coated with one or more coating layers and the material of the intermediate substrate 120 may be selected and configured to allow the powder 130 to temporarily adhere to one of the coating layers on the exterior surface 125. Further, the type of directed energy device 150 may be selected and configured such that the directed energy 155 removes or vaporizes the coating layer adjacent to the adhered powder 130 to separate the adhered powder 130 from the exterior surface 125. In some implementations, the material of the intermediate substrate 120 and type of directed energy device 150 may be selected and configured to allow one or more coating layers and adhesive layers to be added to the outer surface of the intermediate substrate 120 such that the powder 130 adheres to at least one of the adhesive layers and the directed energy 155 removes or vaporizes only certain adhesive layer(s) to separate the powder 130 from the exterior surface 125.

In some implementations, the material of the intermediate substrate 120 and type of directed energy device 150 may be selected and configured to facilitate heating of the powder 130 and vaporization of one or more monolayers of the powder 130 at an interface between the volume of powder 130 and the exterior surface 125. In one implementation, the directed energy device 150 may facilitate heating and vaporization of one or more monolayers of material adherent to the exterior surface 125 to facilitate separation and transfer of the volume of powder 130 beneath the one or more monolayers of adherent material. The vaporization of one or more interfacial monolayers of the powder 130 can facilitate separation of a volume of the powder 130 from the exterior surface 125 without changing the powder microstructure of the volume powder 130.

In some implementations, the material of the intermediate substrate 120 and type of directed energy device 150 may be selected and configured to facilitate direct heating and vaporization of a portion of interfacial particles of the powder 130. The interfacial particles of the powder 130 being adhered to the exterior surface 125 and positioned between the volume of powder 130 and the exterior surface 125. The applied directed energy 155 can be configured to vaporize portions of interfacial particles of the powder 130 without changing the powder microstructure of the separated volume powder 130. Any combination of the above embodiments may be readily contemplated to facilitate adherence of a volume of powder 130 to the intermediate substrate 120 and transfer of the volume of powder 130 from the intermediate substrate 120 to the substrate 140 without changing the powder microstructure of the volume of powder 130. Moreover, one or more transfer regions 123 and one or more directed energy sources 150 may be implemented to facilitate immediate or gradual application of directed energy to remove a volume of powder 130 from the intermediate substrate 120. Further, additional transfer regions 123 and directed energy sources 150 may be implemented to remove residual powder 130 to facilitate, for example, cleaning of the intermediate substrate 120.

In some embodiments, the directed energy directly vaporizes one or more monolayers of the powder or material adherent to the surface of the powders (such as surface adherent H20 or carbonaceous species) without substantial heating of the powders. This vaporization may be accomplished by using energetic sources such as pulsed UV lasers which can directly vaporize or ablate surfaces without substantial heating of the powder. Such vaporization may be limited to those powders directly adjacent to the outer surface of the intermediate substrate by appropriate selection of the properties or the energetic source (such as wavelength of a laser energetic source) and properties of the powder (such as a strong absorption allowing the energy to be absorbed immediately at the powder surface).

In some embodiments focused acoustic energy is used as the directed energy source to transfer momentum to the powder. Such momentum transfer removes the adhesion of the powder to the outer surface of the intermediate substrate.

### Materials and Sources

In a further aspect of the disclosure, the intermediate substrate 120 may be made of one or more non-opaque materials to facilitate transfer of powder 130 from the exterior surface 125 using directed energy 155 applied to an inner surface or interior surface 124 of the intermediate substrate 120 opposite the powder 130. Examples of non-opaque materials include glass, non-opaque acrylic, clear acrylic, plastics, fused silica, transparent ceramics, and so forth, however any clear, transparent, or translucent material may be used. In some embodiments, the intermediate substrate 120 may be made of non-opaque materials to allow the directed energy 155 to substantially pass through the material and transferred to the powder adhered to the exterior surface 125. The directed energy 155 may then remove adherence of the powder 130 to the exterior surface 125 without altering the powder microstructure of the volume of powder 130.

In certain implementations, the intermediate substrate 120 may be made of one or more opaque materials to facilitate transfer of powder 130 from the exterior surface 125 using directed energy 155 applied to at least one of an inner surface or interior surface 124 and an exterior surface or exterior surface 125 of the intermediate substrate 120. Examples of opaque materials include aluminum, steel, stainless steel, hardened steel, or other metals and alloys. In some embodiments, the intermediate substrate 120 may be made of opaque materials to allow the directed energy 155 to be substantially absorbed by the material and transferred to the powder 130 adhered to the exterior surface 125. The directed energy 155 may then remove adherence of the powder 130 to the exterior surface 125 without altering the powder microstructure of the volume of powder 130.

Moreover, in some implementations the material(s) of the intermediate substrate 120 may be made to have in part, or in whole, an amorphous, crystalline, or semi-crystalline structure to prevent/minimize damage to the intermediate substrate 120, to prevent changes in powder properties of the powder 130, and to facilitate sufficient energy transfer to remove adherence of the powder 130 from the exterior surface of the intermediate substrate 120. In certain embodiments, the exterior and/or interior surface of the intermediate substrate 120 may be made of specific micro-porous materials including metals, fibers, polymers, carbon, and so forth, as an example. Moreover, the interior surface 124 and/or exterior surface 125 of the intermediate substrate 120 may be made to be micro-porous or formed with micro-openings to facilitate adhesion of powder 130 to the micro-porous surface, transfer of powder 130, for example, lasing/air jetting powder through micro-openings, heating or applying directed energy to the powder 130 through the micro-openings, or any combinations thereof.

In a further aspect of the disclosure, the directed energy source 150 may include any technology that can emit energy in a focused manner. Examples of directed energy sources include electromagnetic, acoustic, particle-based systems, plasma-based systems, and hybrid systems. Some examples of electromagnetic energy sources that may be implemented include lasers, continuous wave lasers, gas lasers ((e.g., CO2 lasers, argon-ion lasers), solid-state lasers (e.g., Nd: YAG lasers, fiber lasers), semiconductor lasers (e.g., diode lasers), pulsed lasers, excimer lasers (ultraviolet laser technology), femtosecond lasers (ultrafast pulses), multi-laser arrays (e.g., each laser having a different direct energy and/or frequency, pulsed lasers, etc.,), microwave and radio frequency (RF) systems, infrared and ultraviolet (non-laser) sources such as infrared heaters or emitters and ultraviolet lamps (e.g., mercury vapor lamps, LED UV sources), and x-ray sources such as x-ray generators. Some examples of acoustic energy sources that may be implemented include sound/acoustic waves with or without focusing, ultrasonic waves with or without focusing, ultrasound/ultrasonic devices, high-intensity focused ultrasound (HIFU) systems, infrasonic waves such as subsonic speakers or emitters. Some examples of particle-based systems that may be implemented include charged particle beams, electron beams, proton beams, neutral particle beams, neutron sources. Some examples of plasma-based systems that may be implemented include plasma energy sources such as plasma torches, and magnetically confined plasma. Some examples of hybrid systems that may be implemented include laser-induced plasmas (combining lasers with plasma physics), electromagnetic-particle beam systems (e.g., particle accelerators), phononic energy sources, and acousto-optic devices that combine light and sound waves for beam steering. The directed energy source 150 may be configured to work with particle sizes less than 500 um (e.g., dry loose powder, flowable powder, etc.,) and deposit voxel thickness from sub-micron to 500+ microns, as an example.

### Controller and Movements:

In a further aspect of the disclosure, the directed energy device 150 may be configured to move along a longitudinal direction (or a tangential direction to the motion of the intermediate substrate, in case of intermediate substrate 120 being a rotating body), that is, horizontal to the volume enclosed by the movement of the exterior surface of the intermediate substrate 120 (X-direction), along a direction vertical to the movement of the intermediate substrate 120 (Z-direction), and along a direction lateral or axially to the movement of the intermediate substrate 120 (Y-direction). As described above, in some embodiments, the directed energy device 150 may be positioned inside the intermediate substrate 120 within a cavity 122 of the intermediate substrate 120. In certain implementations, the directed energy device 150 may be positioned externally to the intermediate substrate 120. In some implementations, a plurality of directed energy devices 150 may be implemented and positioned inside the intermediate substrate 120, external to the intermediate substrate 120, or any combination thereof. In some implementations, the directed energy device may be external to the intermediate substrate, but the energy may be directed to the internal region by the use of reflecting devices, mirrors, fiber conduits, waveguides, or other means of direction.

In a further aspect of the disclosure, the funnel 110 may be configured to move along a longitudinal direction, horizontal to the volume enclosed by the movement of the exterior surface of the intermediate substrate 120 (X-direction), along a direction vertical to the movement of the intermediate substrate 120 (Z-direction), and along a direction lateral or axially to the movement of the intermediate substrate 120 (Y-direction). Similarly, the intermediate substrate 120 may be configured to be repositioned in a longitudinal direction (X-direction), repositioned in a direction vertical to the movement of the intermediate substrate 120 (Z-direction), and repositioned in a direction lateral or axially to the movement of the intermediate substrate 120 (Y-direction). The smoothing blade 115 may be configured to move along a longitudinal direction (X-direction), along the lateral or axial movement of the intermediate substrate 120 (Y-direction), and along a direction vertical to the movement of the intermediate substrate 120 (Z-direction). The substrate 140 may be configured to move along a longitudinal direction (X-direction), along a direction vertical to the movement of the intermediate substrate 120 (Z-direction), and along a direction lateral or axially to the movement of the intermediate substrate 120 (Y-direction).

In a further aspect of the disclosure, the controller 105 may be programmed to independently adjust and synchronize the XYZ movement and powder deposition rate of funnel 110, the XYZ movement and rotation speed of the intermediate substrate 120, the XZ movement of the blade 115, the XYZ movement and the applied directed energy from directed energy device 150, the speed and XYZ direction of the substrate 140, and the rate/power of operation (e.g., adjusting speed, power, or frequency) and XYZ direction of pre-conditioning devices and post-conditioning devices (as shown in FIGS. 4 and 5A-5B). These adjustments and synchronizations may include matching the rate of motion in some or all directions such as matching the X motion of the substrate to the tangential motion of the intermediate substrate, for example, when the intermediate substrate is a rotating body or belt. This matching of motion may be accomplished though programming of the controller and/or by the use of physical contact of portions of the intermediate substrate to the target substrate. The contact portions may be raised standoffs, ridges, guides, stencils, or embossing/debossing the outer surface of the intermediate substrate to enable contact of the intermediate substrate to the substrate and avoiding, minimizing, or controlling contact of the adherent powder to the substrate to avoid disturbing the powder adherent to the exterior surface of the intermediate substrate prior to application of the directed energy.

In a further aspect of the disclosure, in some embodiments, the directed energy may have an energy density of between approximately 0.1-30 J/cm² may be suitable for removal, separation, or vaporization of a surface of attached/adhered particles to the intermediate substrate. That is, the directed energy provides the minimum required effective energy necessary to separate the adhered surface of the dry powder particle attached to the intermediate substrate. In certain embodiments, the energy density may be significantly less (e.g., 10-15% of vaporization energy density) to disturb an adherence of the dry powder to the intermediate substrate without changing the powder particle microstructure. For example, the disturbance energy density may be between ˜0.01-10 J/cm² to disturb an adherence of the dry powder particles to facilitate transfer of the dry powder to a target substrate. In some implementations, the applied energy/power from the directed energy device may be kept below a threshold that would fuse the dry powder particles or damage a significant fraction of the volume of dry powder transferred (e.g., less than between 10% by volume). As can be readily contemplated, higher and lower ranges may be applied based on dry powder composition, intermediate substrate material(s) selection, and material(s) used for the transfer layer, coating layer, or adhesion layer on the intermediate substrate. Some examples of non-thermal direct energy sources include acoustic agitation, disturbance, and removal of powder from an intermediate substrate using acoustic cavitation (bubble formation and collapse), radiation pressure (direct force applied by sound waves), and resonant vibrations (shaking loose adhered particles). Since dry powder particles can be loosely bound, the acoustic energy required for inducing mechanical stress or cavitation forces to dislodge or disturb an adherence of the powder to the intermediate substate to transfer the volume of powder can be much lower than the energy required for thermal vaporization of a thin layer of powder.

### Powder Transfer Device

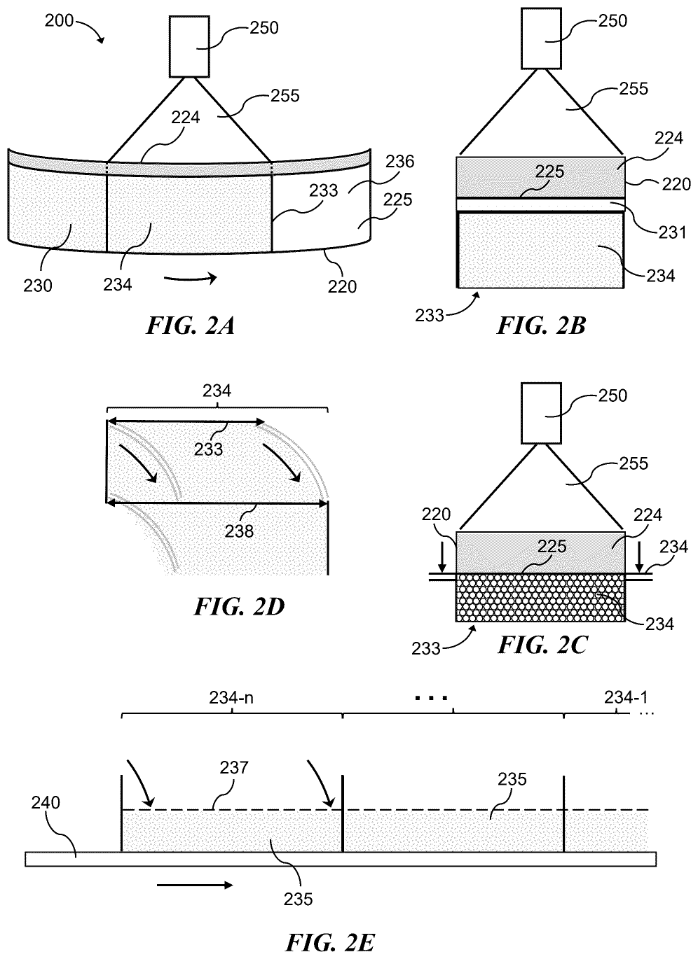

With reference to FIGS. 2A-2E, some implementations of a directed energy system that may be used in a powder transfer system are illustrated, the powder transfer system being configured for direct deposition of patterned powder and precise control of powder feature size, shape, and uniformity while improving powder deposition speed onto a conveyor or continuous substrate. In various embodiments and examples described herein, a directed energy device facilitates transfer of powder deposited on a moving intermediate substrate to a conveyed target surface or substrate. The powder may adhere to an exterior surface of an intermediate substrate. An upper surface of the powder adjacent to the exterior surface may form an interface between the exterior surface of the intermediate substate and the volume of powder underneath the interface. The interface, or the adhered upper surface of the powder, may be disrupted or applied with a directed energy to facilitate transfer of the volume of powder onto a target substrate underneath the intermediate substrate. In many embodiments, the directed energy device may be configured in a number of ways to disrupt an adhesion of an adhered layer of the powder to the intermediate substrate as described herein. In some implementations, the volume of powder underneath the adhered layer is separated through direct energy disruption. In certain embodiments, the adhered layer is disrupted and removed, in part or in whole, leading to the volume of powder underneath the adhered layer and the adhered layer to become separated from the exterior surface of the intermediate substrate. Additionally, the powder and/or the powder transfer system may be configured in a number of ways to adhere, and maintain adherence of, the powder to the intermediate substrate. In many embodiments, the powder and/or the powder transfer system (e.g., intermediate substrate to target substrate powder transfer) may be treated or conditioned to facilitate adherence of the powder to the intermediate substrate, removal of the powder from the intermediate substrate without altering the powder microstructure, cleaning of the intermediate substrate, coating of the intermediate substrate, and controlled powder mass flow and uniform powder deposition onto the conveyed target surface or substrate, for example.

FIGS. 2A-2C illustrate an example processing of the intermediate substrate to facilitate adherence of powder to the exterior surface and removal of the powder from the intermediate substrate. In one implementation, the directed energy device 250 may apply directed energy 255 to an interior surface 224 of the intermediate substrate 220. In some embodiments, the interior surface 224 may include one or more inner or interior layers adjacent to an inside surface opposite to the exterior surface 225 having a different material, structure, or surface features. As an example, one or more inner layers may include gratings or patterns to absorb or redirect the directed energy 225 to prevent damage to the intermediate substrate 220 or volume of powder 234. Similarly, the exterior surface 225 may include one or more outer or exterior layers adjacent to an outside surface opposite to the interior surface 224 having a different material, structure, or surface features. As an example, one or more outer layers may include material of higher density to prevent damage to the volume of powder 234. The interior surface 224 (inner layers) and exterior surface 225 (outer layers) may be designed as desired to facilitate adhesion of a volume of powder 234, coating of the exterior surface 225, resistance to wear of the intermediate substrate 220 from prolonged usage, ease of cleaning of the intermediate substrate 220, and to minimize or prevent damage to the powder microstructure, as some examples.

Referring to FIG. 2A, in one implementation, a directed energy device can be applied to a predetermined target region of an intermediate substrate to facilitate various powder transfer system implementations as described herein. In a further aspect of the disclosure, the directed energy system 200 includes a directed energy device 250 for applying a directed energy 255, an intermediate substrate 220 with an interior surface 224 and an exterior surface 225, and at least one transfer region 233 selected for the interior surface 224 or the exterior surface 225 where the directed energy 255 is to be applied to transfer a volume of powder 234. In one implementation, the exterior surface 225 includes a portion covered with powder 230, a portion having at least one transfer region 233 for removal of a volume of powder 234, and a treated portion 236 where a volume of powder was removed therefrom and thus having substantially no powder. Further, in one embodiment, the directed energy device 250 may be positioned to be adjacent to, or facing, an exterior side of the intermediate substrate 220. In certain embodiments, the directed energy device 250 may be positioned to be adjacent to, or facing, an interior side of the intermediate substrate 220.

Referring to FIG. 2B, in one implementation, an example processing of the intermediate substrate is illustrated for facilitating adherence of powder to the exterior surface and removal of the powder from the intermediate substrate. In one embodiment, the exterior surface 225 may include a transfer layer 231. The transfer layer 231 may be added or removed from the exterior surface 225. The transfer layer 231 may be added, for example, and not by way of limitation, spray coating, film coating, physical or chemical deposition methods, printing and coating techniques, mechanical layer application, or any combinations thereof, as is well known in the art. The transfer layer 231 may be removed, for example, and not by way of limitation, mechanical or chemical methods such as sanding, polishing, peeling, etching, thermal methods, directed energy methods, physical and electrochemical methods, or any combinations thereof, as is well known in the art.

In a further aspect of the disclosure, the transfer layer 231 may consist of only one coating layer or one adhesive layer. For example, the transfer layer 231 when applied as a coating layer may protect the exterior surface 225 of the intermediate substrate 220 from damage through prolonged usage as is well known in the art. In one embodiment, the transfer layer 231 may include one coating layer and one adhesive layer. For example, the transfer layer may be configured with a coating layer and an adhesive layer to facilitate adhesion of the volume of powder 234 and protection of the exterior surface 225 of the intermediate substrate 220 from damage through prolonged usage. In certain embodiments, the transfer layer 231 may include one or more coating layers and one or more adhesion layers. Moreover, in some implementations, the transfer layer 231 may include one composite layer that facilitates a coating layer to protect the intermediate substrate 220 and an adhesive layer to facilitate adhesion of the powder to the exterior surface of the intermediate substrate 220.

In one implementation, the transfer layer 231 may include one or more adhesion layers. In some implementations, the intermediate substrate 220 may be precoated with one or more adhesive materials to form adhesive/release layers such as a thin liquid, gel, polymer, molecular layer, or the like which can interact favorably with the transfer or release mechanism described herein. The adhesive material for the transfer layer 231 may be selected from any material(s) capable of attracting powder 230 and facilitating adhesion of the deposited powder 230 to the exterior surface 225 during movement of the intermediate substrate 220. In some embodiments, the transfer layer 231 may be periodically treated or conditioned on the intermediate substrate in order to maintain powder adhesion. For example, the transfer layer 231 may be sprayed with a thin layer of material to improve powder adhesion of the transfer layer 231. In various implementations, the thickness of the transfer layer 231 may be defined in a range from 0.10 nm to 1.00 mm. In various implementations, the thickness of an adhesive layer of the transfer layer 231 may be defined in a range from 0.10 nm to 1 mm. In one embodiment, the transfer layer 231 may be defined as consisting of only one adhesive layer, the thickness of the adhesive layer being defined in a preferable range from 1.00 um to 7.00 mm. In various implementations, the thickness of a coating layer when applied onto the exterior surface 225 as the transfer layer 231 may be defined in a range from 1.00 nm to 1 mm. In one implementation, the transfer layer 231 may be coated as only one layer of an adhesive layer or a coating layer, whereby the one layer is deposited as a monolayer on the intermediate substrate having a thickness of only one molecule.

In one implementation, the exterior surface 225 may be coated with the transfer layer 231 to facilitate adhesion of a volume of powder 234. The transfer layer 231 may then be vaporized to remove the adhesion of the volume of powder 234 to the exterior surface 225. In some embodiments, the transfer layer 231 may be selectively vaporized based on the location and volume of powder 234 desired to be transferred to a target substrate. Once the location and volume of powder 234 aligns or approaches a transfer region 233, the transfer region 233 may be applied with directed energy 255 to vaporize the transfer layer 231 to transfer the volume of powder 234 to a target substrate or surface. The transfer layer 231 and remaining powder 230 may then be removed. The exterior surface 225 may be subsequently coated with one or more transfer layers 231 thereby ensuring subsequently deposited powder 230 is not contaminated by remaining powder 230 or transfer layer 231 on the exterior surface 225. Moreover, the dimensions and geometry of the transfer region 233 and transfer layer 231 may be configured as desired for adjusting the volume of powder 234 transferred to the target substrate. The dimension and geometry of the transfer region 233 and transfer layer 231 shown herein are examples and other dimensions and geometries may be readily contemplated to adjust a powder mass flow rate onto the target substrate as well as the uniformity of powder deposited onto the target substrate. For example, the transfer region 233 may be polygonal in shape, for example, a trapezoid or parallelogram may be defined such that the applied directed energy 255 facilitates a desired powder mass flow rate and deposition of a uniform and smooth powder layer onto the target substrate.

Referring to FIG. 2C, in one implementation, an example processing of the intermediate substrate is illustrated for facilitating adherence of powder to the exterior surface and removal of the powder from the intermediate substrate without changing the microstructure of the volume of powder 234. In a further aspect of the disclosure, the deposited powder 230 may be engineered to have sufficient cohesion such that a volume of powder 234 remains on the intermediate substrate 220 when the intermediate substrate is rotated/inverted without an adhesive layer. This can be accomplished by engineering the particle size distribution of the powder to enhance the cohesion. Reducing the median particle size to less than 50 um and preferably less than 20 um may be used to enhance the cohesion. Adjusting the powder to include at least 1% of fine particles with a diameter of less than 10 um and preferably less than 5 um may also be useful to enhance the cohesion. In addition, adjusting the surface coating on the powder particles can enhance the cohesion of the powder by enhancing the attractive interaction between the particles. In certain implementations, the deposited powder 230 may be engineered to have sufficient adhesion such that a volume of powder 234 adheres to the intermediate substrate 220 when rotated/inverted through, for example, interparticle forces and electrostatic forces. In alternative or additional implementations, the powder 230 may be physically or mechanically smoothed out and/or compacted onto the intermediate substrate 220 to facilitate adhesion. The interfacial particles of the volume of powder 234, that is, particles directly adjacent to, and adhered to, the exterior surface 225 facilitate adhesion of the volume of powder 234 to the exterior surface 225. It follows then, in one implementation, the directed energy 255 may be configured and applied to one or more transfer regions 233 such that a portion of only interfacial particles of the volume of powder 234 are vaporized or partially vaporized thereby removing adherence of the volume of powder 234 from the exterior surface 225. In certain embodiments, portions of the interfacial particles of the volume of powder 234 are vaporized to remove adherence of the volume of powder 234 from the exterior surface 225. Whereas, in some implementations, the directed energy 255 may be applied to an interior surface 224 of the intermediate substrate 220 to disrupt an adhesion of interfacial particles of the volume of powder 234 facilitating separation of the volume of powder 234. Further, in some implementations, the directed energy 255 may be applied to an exterior surface 225 of the intermediate substrate 220 to disrupt an adhesion of interfacial particles of the volume of powder 234 facilitating separation of the volume of powder 234. Any separated and intact interfacial particles applied with directed energy 255 and within the volume of powder 234 may then be further processed on the target substrate. For example, the transferred powder on the target substrate may be treated and conditioned to facilitate cohesiveness of the transferred powder and adhesion of the transferred powder to the target substrate.

In one implementation, one or more interfacial monolayers of the volume of powder 234 directly adjacent to, and adhered to, the exterior surface 225 may be vaporized to transfer the volume of powder 234. It follows then, the directed energy 255 may be configured and applied to one or more transfer regions 233 such that only one monolayer of the volume of powder 234 is vaporized thereby removing adherence of the volume of powder 234 from the exterior surface 225 without changing the powder microstructure of the volume of powder 234. Moreover, in some implementations, a plurality of monolayers of the volume of powder 234 are vaporized to remove adherence of the volume of powder 234 from the exterior surface 225 without changing the powder microstructure of the volume of powder 234. The remaining monolayer(s) applied with directed energy 255 and within the volume of powder 234 may then be treated and conditioned as part of the volume of powder 234, for example, to facilitate cohesiveness of the transferred powder and adhesion of the transferred powder to the target substrate.

FIGS. 2D-2E illustrate an example powder volume transfer from the exterior surface of the intermediate substrate upon application of directed energy to the intermediate substrate. The powder volume transfer from the intermediate substrate may form a powder layer on the target substrate. In one embodiment, application of directed energy to the transfer region 233 may facilitate waterfall powder transfer from the exterior surface 225 of the intermediate substrate 220, as shown in FIG. 2D. However, other types of powder transfer may be contemplated based on the design of the transfer region 233, use of one or more transfer layers 231, arrangement of powder volume 234 on the intermediate substrate 220 (e.g., thickness, cohesiveness, adhesion, compaction, etc.,), various conditioning and processing devices for facilitating adhesion and powder removal (as shown in FIGS. 4 and 5A-5B), and configuration of the directed energy 255 and/or directed energy devices 250. For example, in one implementation, the transfer region 233 may be positioned away from the lowest point of the intermediate substrate 220 (e.g., intermediate substrate 120) such that vaporization of the transfer layer 231 coupled with the motion of the intermediate substrate 220 can facilitate peel off powder transfer of the powder volume 234 from the exterior surface 225 of the intermediate substrate 220 to form a powder layer 235. Referring to FIG. 2E, in one implementation, an example powder layer may be formed by the example powder volume transfer upon application of directed energy to the exterior surface of the intermediate substrate by the directed energy system. In one implementation, the directed energy system 200 may be configured such that each deposited powder volume 234-1 . . . 234-n has the same powder thickness 237 and forms a powder layer 235 on a target substrate 240.

In some implementations, the continuous substrate 240 may be moving in a direction along the X-axis away from the directed energy device 250 and the intermediate substrate 220 towards and past a right edge of the intermediate substrate 220. Further, the length and thickness of the powder layer 235 may be substantially equal to the length and thickness of the adhered volume of powder 234. In some implementations, the length/width of the transfer region 233 and the length/width of the volume of powder 230 transferred onto the continuous substrate 240 are substantially equal. Moreover, in certain implementations, the volume of powder 234 directly above (vertically above) the continuous substrate 240, at the lowest point of the intermediate substrate 220 may be transferred to the continuous substrate 240.

### Intermediate Substrate Surfaces

FIGS. 3A-3C illustrate various example exterior surfaces of an intermediate substrate 320 that may be utilized with the various powder transfer system implementations described herein. FIGS. 3A-3C illustrate examples of intermediate substrates 320 having an interior surface 324 and an exterior surface 325. In a further aspect of the disclosure, the surface features and properties of the intermediate substrate 320 may be configured such that the powder 230 adheres to the intermediate substrate 320 when the surface of the intermediate substrate 320 is inverted. Referring to FIG. 3A, in one implementation, an example exterior surface 325 includes surface feature 326 patterned to have a rough surface, saw-edge surface, or toothed surface of a predetermined periodicity for facilitating adhesion of powder 230 to the exterior surface 325. As another example, exterior surface 325 may include micro-surface features 326 patterned to have a porous, matte, brushed, etched, micro-rough, or sandpaper-like texture spread across the exterior surface 325 to facilitate powder adhesion. The various surface patterns described herein for surface features 326 may be used individually or combined and spread across the exterior surface 325 to facilitate powder adhesion. In some embodiments, the interior surface 324 may include one or more surface features described herein to aid or facilitate removal of powder from the intermediate substrate 320. As an example, one or more surface features 326 may be implemented on the interior surface 324 to adjust or control a level of heating of the intermediate substrate 320 to facilitate removal of the powder 230 without changing the microstructure of the particles of the powder.

Further, the surface features 326 may be spread randomly or semi-periodically across the exterior surface 325. Moreover, the surface features 326 may be treated or conditioned as described herein to facilitate adhesion of the powder 230 to the intermediate substrate 320. Conditioning methods and surface features 326 may be varied and implemented as needed based on particulate sizes of the powder 230. In various implementations, the height of the surface features 326, from base/bottom to tip or edge of a surface feature, may be defined in a range from 10 nm to 30 um based on the properties and size of particles of the powder 230. Similarly, the spacing or pitch (or density of surface features) between each surface feature 326 may be defined in a range from 1 um to 100 um, based on the properties and size of particles of the powder 230.

Referring to FIG. 3B, in one implementation, an example exterior surface 325 includes surface features 326 patterned to have a plurality of grooves 327 and protrusions 328 spread across the exterior surface 325 to facilitate powder adhesion. In various implementations, the height/depth of the grooves 327 and protrusions 328, from base/bottom to tip or edge of a surface feature, may be defined in a range from 10 nm to 30 um based on the properties and size of particles of the powder 230. Similarly, the spacing or pitch between each surface feature 326 may be defined in a range from 10 nm to 30 um, based on the properties and size of particles of the powder 230. Further, in certain embodiments, the surface features 326 (e.g., grooves and protrusions) may be random or patterned as needed to facilitate powder adhesion.

Referring to FIG. 3C, in one implementation, an example exterior surface 325 of the intermediate substrate 320 includes surface features 326 patterned to have a smooth or polished surface. As described below, in various implementations, the powder transfer apparatus can include processing, coating, or conditioning of the intermediate substrate 320 and/or powder to aid in powder transfer, powder adhesion, recycling/collection of powder, and cleaning the intermediate substrate 320. In various implementations, the powder transfer apparatus can facilitate uniform powder deposition and improve mass flow while minimizing additional processing and components that can reduce the flowability and cohesiveness of the dry powder during the process of powder deposition onto a target substrate.

Referring to FIG. 3D, in one implementation, an example exterior surface 325 of the intermediate substrate 320 may be modified to include one or more permanent stencils 329 that may be of any shape. The stencil 329 may be a recess, cavity, or other surface feature for retaining powder 330. The exterior surface 325 may then be smoothed out by a blade 115 or blade 515 (as shown in FIGS. 1 and 5A) to remove powder outside of the stencil 329 to facilitate powder transfer having the shape of the stencil from the intermediate substrate to a target substrate. The surfaces of the stencil 329 may have the same properties as the exterior surface 325 as described herein to facilitate adhesion of powder 130.

### Powder and Powder Transfer Apparatus Processing, Conditioning, and Collection

With reference to FIG. 4, one implementation of a powder transfer system is illustrated. The powder transfer system 400 may include one or more units for processing and conditioning of the intermediate substrate and one or more units for processing, conditioning, and collection of powder. The powder transfer system 400 may facilitate uniform powder deposition and improve mass flow while minimizing additional processing and components that can reduce the flowability and cohesiveness of the dry powder during the process of powder deposition onto a target substrate, in accordance with aspects of the present disclosure. The powder transfer system 400 may include one or more conditioning units for smoothing, compacting, and adhering the powder to the intermediate substrate, and conditioning units for cleaning and treating the intermediate substrate for subsequent powder deposition and/or prolonged usage.

### Powder Deposition, Smoothing, and Compaction

In a further aspect of the disclosure, the powder transfer system 400 may include a powder distribution device 410 for containing (storing) and dispensing powder 430 onto an intermediate substrate such as, for example, an intermediate substrate 420. In certain implementations, the powder transfer system 400 may include one or more conditioning units such as, for example, blade 411 configured to smooth a powder or material dispensed onto the intermediate substrate 420. In some embodiments, the blade 411 may be configured to move independently of the intermediate substrate 420 in the X, Y, or Z direction, based on the amount of powder 430 on the intermediate substrate 420, to gradually smooth out the powder along the upper portion of the intermediate substrate 420. Moreover, one or more blades 411 may be positioned and spaced apart along the upper portion of the intermediate substrate 420. The one or more blades 411 may be moved in the X, Y, or Z direction to gradually smooth out the dispensed powder 430 and/or block/allow passage of dispensed powder 430 for a predetermined thickness on the intermediate substrate 420.

In a further aspect of the disclosure, a conditioning unit may include one or more stationary or rotating rollers 412 adjacent to the intermediate substrate 420 and configured for smoothing the powder 430 to desired surface uniformity and/or thickness. In certain implementations, the powder transfer system 400 may include one or more conditioning units for powder compaction, for example, one or more stationary or rotating rollers 412 may be positioned adjacent to the intermediate substrate 420 and configured for compacting the powder 430 to a desired thickness. As can be readily contemplated, repeat or sequential application of the blade 411, roller 412, or other compacting or smoothing devices or methods may be used to maintain and/or restore the desired thickness and uniformity of the dry powder on the intermediate substrate. The smoothing device may also be a counter rotating roller.

### Powder Adhesion and Cohesiveness of Powder

In a further aspect of the disclosure, in some implementations, a conditioning unit may include one or more spray/coating device 413 for spraying or coating the exterior surface of the intermediate substrate 420 using at least one of a film coating or spray coating. In some embodiments, the coating or film may form a transfer layer for facilitating adhesion and/or transfer of the powder 430 as described herein. In one embodiment, the spray/coating device 413 may spray coat the powder 430 to improve a cohesiveness of the dry powder on the intermediate substrate 420. The coating or film may be an adhesive/release layer such as a thin liquid, gel, polymer, or molecular layer which can interact favorably with adhesion and transfer means and devices described herein. In certain implementations, a conditioning unit may include one or more heating devices 414 for heating the exterior surface of the intermediate substrate 420 to improve adhesion of the dry powder to the intermediate substrate 420. In one embodiment, the heating device 414 may apply heat to the powder 430 to improve a cohesiveness of the dry powder on the intermediate substrate 420. This can be accomplished both in non-contact (e.g., with infrared radiation) or in contact (e.g., with a heated roller).

In some implementations, a conditioning unit may include one or more electrostatic chucks 415 configured to apply an electric charge to the intermediate substrate 420 to make the powder 430 adhere to the exterior surface of the intermediate substrate 420. In certain implementations, a conditioning unit may include a vacuum means or means to create a pressure differential, with the ambient environment, sufficient to adhere powder 430 onto the exterior surface of the intermediate substrate 420. As an example, the intermediate substrate 420 may include a plurality of micro-openings (not shown) or a micro-porous surface/material and a vacuum chuck 416 positioned within the intermediate substrate 420 to suction/vacuum or create a pressure differential between the ambient environment sufficient to adhere powder 430 to the intermediate substrate 420 when the deposited powder 430 is in an inverted position. Moreover, the cohesiveness of the powder 430 may further facilitate adhesion onto the exterior surface of the intermediate substrate 420 when the deposited powder 430 is in an inverted position.

The powder may be conditioned after smoothing but before inversion by application or infusion of a liquid or vapor. Liquids are known to increase the cohesion of powders by forming microscopic bridging between the powder particles which enhances the cohesion of the volume of powder during transfer. Example liquids or vapors could be water, alcohols such as isopropanol, esters such as propyl acetate, and other high or low volatile organic solvents.

### Powder Transfer

In a further aspect of the disclosure, in some implementations, a conditioning unit may include one or more transfer devices (i.e., for material transfer) to facilitate transfer of powder 430 from the exterior surface of the intermediate substrate 420 to a substrate 440. In one embodiment, the powder transfer system 400 may include a drum, belt, or web (e.g., a continuous sheet of foil or film such as are used in roll-to-roll processing) as the substrate 440 for transporting powder 430 transferred by the intermediate substrate 420 as a powder layer 435. In certain implementations, a conditioning unit may include one or more electrostatic chucks 415 configured to apply an electric charge of reverse polarity to the intermediate substrate 420 to repel the powder 430 from the exterior surface of the intermediate substrate 420. In one implementation, a conditioning unit may include an air jet device 418 positioned exterior to, or within, the intermediate substrate 420 and configured to apply one or more jets to the powder 430 to repel to push powder 430 off the exterior surface of the intermediate substrate 420. In one embodiment, the air jet device 418 may apply jets at the interface between the powder 430 and the exterior of the intermediate substrate 420 to transfer the volume of powder 430 to substrate 440. In certain embodiments, the air jet device 418 may apply jets through one or more micro-openings or micro-porous surface of the intermediate substrate 420. In one embodiment, the air jet device 418 may apply jets at or near the transfer region 233 to transfer powder 430 to substrate 440. As can be readily contemplated, repeat or sequential application of the electrostatic chucks 415, air jet device 418, and directed energy from directed energy device 450, or other transfer devices or methods may be used to transfer the desired volume of the dry powder from the intermediate substrate 420 to the substrate 440.

Referring to again to FIG. 4, one or more adhesion and/or transfer means and devices may be implemented to facilitate transfer of powder 430 onto substrate 440 as a powder layer 435 with uniform thickness and smooth surface. The controller 405 may be programmed to independently adjust and synchronize the XYZ movement and powder deposition rate of powder distribution device 410, the XYZ movement and rotation speed of the intermediate substrate 420, the XZY movement of the conditioning units described herein. For example, the gap between the intermediate substrate 420 and the substrate 440 may be adjusted to facilitate continuous and fluidic transfer of powder 430 such that the surface of the powder layer 435 is substantially smooth. The conditioning units may be implemented as needed to ensure the flowability and cohesiveness of the deposited powder 430 is maintained in the transferred powder layer 435. Moreover, the transferred powder layer 435 may be further processed using one or more heating devices 419 to maintain flowability and cohesiveness of the powder in powder layer 435, as well as facilitating adhesion of the powder to the substrate 440.

### Cleaning and Powder Recycling

In a further aspect of the disclosure, in some implementations, a conditioning unit may include one or more cleaning devices for cleaning the exterior surface of the intermediate substrate 420 to remove residual powder after the volume of the dry powder is transferred from the intermediate substrate 420 to the substrate 440. As described above and herein, various transfer devices and means may be further implemented to transfer, clean, or remove powder 430 from the intermediate substrate 420. In one implementation, a conditioning unit may include a rotating or oscillating brush 417 configured to brush powder off of the exterior surface of the intermediate substrate 420. In one implementation, a vacuum device may be used to remove powder from the exterior surface of the intermediate substrate 420. In some implementations, one or more lasers or directed energy devices may be used to remove powder from the exterior surface. In certain embodiments, the powder transfer system 400 may include a conveyed substrate 460 (or receptacle) to capture and facilitate transfer of non-transferred powder 430. Further, when a conveyed substrate 460 is implemented, the recycled powder 430 transferred by the oscillating brush 417 may be transported as a powder layer 465 to a container or receptacle for disposal, recycling, or reuse. In one implementation, a conditioning unit may include an air jet device 418 positioned exterior to, or within, the intermediate substrate 420 and configured to apply one or more jets to the powder 430 to repel to push powder 430 off the exterior surface of the intermediate substrate 420 and into a receptacle (not shown) or the conveyed substrate 460. Further, in some implementations, a conditioning unit may include one or more electrostatic chucks 415 configured to apply an electric charge of reverse polarity to the intermediate substrate 420 to repel the powder 430 from the exterior surface of the intermediate substrate 420 into a receptacle (not shown) or the conveyed substrate 460. As can be readily contemplated, repeat or sequential application of the electrostatic chucks 415, oscillating brush 417, air jet device 418, or directed energy from an exterior placed directed energy device 450, or other transfer devices or methods may be used to transfer the desired volume of the dry powder from the intermediate substrate 420 to the substrate 460 to facilitate cleaning of the exterior surface of the intermediate substrate 420. Moreover, the powder 430 (e.g., dry loose powder) may be engineered as desired with properties for improved adhesion to the intermediate substrate 420 as well as properties to facilitate ease of transfer from the intermediate substrate 420 such that high precision and high speed (powder mass flow rates) may be achieved.

### Conditioning for Subsequent Run

In a further aspect of the disclosure, in some implementations, a conditioning unit may include one or more pre-conditioning units configured to treat or prepare the intermediate substrate for powder deposition (or subsequent powder deposition). In one implementation, the oscillating brush 417 may be configured to remove remaining powder, coating, coated film/adhesive layer. Moreover, a heating device 419 or external directed energy device 450 may be utilized to remove or vaporize a transfer layer, coating, powder, film, or other layer remaining on the exterior surface of the intermediate substrate 420. Upon removal of any remaining material or layers on the exterior surface of the intermediate substrate 420, one or more conditioning units may be implemented to prepare the exterior surface of the intermediate substrate 420 for powder deposition. In certain implementations, one or more spray/coating device 413 as described herein may be implemented to pre-coat the exterior surface of the intermediate substrate 420 with one or more materials/layers to facilitate powder adhesion. Moreover, the exterior surface of the intermediate substrate 420 may be heated using a heating device 419 to facilitate adhesion of a pre-coat material or layer. Further, the exterior surface of the intermediate substrate 420 may be subsequently heated using a heating device 419 to facilitate adhesion of deposited powder 430 by powder distribution device 410. In some embodiments, remaining powder may be left on the intermediate substrate such that rejuvenation of the dry powder on the intermediate substrate 420 can be accomplished. Powder may be rejuvenated by providing a flowable dry powder to both the exposed zones (transferred powder regions onto substrate 440) and unexposed zones (remaining powder regions) on the intermediate substrate 420 sufficient to fill in the transferred powder regions.

### Powder and Powder Transfer Apparatus Processing and Conditioning

With reference to FIGS. 5A-5B, illustrated are embodiments of a powder transfer system for direct deposition of patterned powder and precise control of powder feature size, shape, and uniformity while improving powder deposition speed, in accordance with aspects of the present disclosure. Referring to FIG. 5A, in a further aspect of the disclosure, an example powder transfer system 500 may integrate or include a plurality of synchronized conditioning units 514, 515, directed energy devices 550, 551, or powder distribution, processing, and transfer devices or means. Further, the controller 505 may be programmed to control each conditioning unit and powder processing device or means (as described in FIG. 4, for example, applying directed energy) to operate concurrently, simultaneously, independently, iteratively, and/or applied gradually to facilitate transfer of a powder volume 534 onto a target substrate 540 as a powder layer 535. In one embodiment, one or more energy devices 550, 551 may be positioned within a cavity 522 of the intermediate substrate 520. In certain embodiments, one or more energy devices 550, 551 may be positioned exterior to the intermediate substrate 520 to apply directed energy 555, 556 onto a first transfer region 532 or second transfer region 533 of the intermediate substrate 520 using one or more filters or adjustment devices (not shown) (e.g., mirrors) to guide and direct the applied energy. The intermediate substrate 520 includes an exterior surface 525 for receiving powder 530 and an interior surface 524 that may be applied with directed energy 555, 556 to disrupt an adhesion of the powder 130 to the exterior surface 525.

In one implementation, the powder transfer system 500 may include a material dispenser 515 to dispense material 531. In one embodiment, the material dispenser 531 may include a blade edge 516 (e.g., a leveler or squeegee). In some embodiments, the material dispenser 515 may be positioned or moved in front of the powder dispensing unit 510 and configured to dispense as the material 531, an adhesive material, gel, film, or layer dispensed onto the intermediate substrate 520 to facilitate powder adhesion. In certain embodiments, the material dispenser 515 may be positioned behind the powder dispensing unit 510 and configured to dispense powder 530, a secondary powder or material 531 such as solvent, additive, binder, or other material as needed, and level or smoothen the powder of powder 530 and dispensed material 531.

In one implementation, the conditioning unit 514 may include a spray coating device and heating device operating concurrently to spray coat powder 530 and/or material 531 and heat the powder to facilitate adhesion and cohesiveness of the powder. Further, in certain implementations, the powder transfer system 500 may include a plurality of directed energy devices 550, 551. A first energy device 551 may apply a directed energy 556 to a first transfer region 532 adjacent, bordering, and/or overlapping/falling within a second transfer region 533 to gradually loosen powder 530 (or powder mixture). A second energy device 550 may apply a pulse of directed energy to transfer or push the powder 530 (or powder mixture) from the exterior surface of the intermediate substrate 520. In one implementation, each of the directed energies 555 and 556 may be made have high precision such that the combined effect to transfer powder 530 (or powder mixture) does not change the rheological properties of the transferred powder volume 534 from the powder 530. In other words, energy devices 550, 551 and conditioning units described herein may be configured such that the dispensed powder 530, transferred powder volume 534, and powder layer 535 have the same rheological properties. In various implementations, one or more filters or adjustment devices (not shown) may be utilized as needed, for example, mirrors, waveguides, diffusers, absorbers, polarizers, prisms, lens, splitters, reflectors, baffles, acoustic panels, isolators, or other devices that may be implemented interior to, or exterior to, the intermediate substrate 520 to filter, tune, isolate, amplify, direct, guiding, or otherwise adjust the applied directed energy.

Referring to FIG. 5B, in one implementation, the intermediate substrate 520 may be configured as a belt or conveyor 523. The intermediate substrate 520 may include one or more rollers 521 configured to move the conveyor 523. The conveyor 523 may include an interior surface 524 and exterior surface 525. In a further aspect of the disclosure, the exterior surface 525 and interior surface 524 of the conveyor 523 move to enclose a volume V. In some embodiments, the exterior surface 525 may directly receive powder 530 from a powder dispensing unit, transport the powder 530 to within a proximity of a moving substrate 540, and then be applied with a directed energy to disrupt the adhesion of the powder 530. In some implementations, a plurality of moving surfaces (e.g., exterior surface 525 and the roller 521 of the intermediate 520) may move and enclose a volume and be applied with a directed energy to disrupt the adhesion of the powder 530. The intermediate substrate 520 may include an exterior surface 525 and an interior surface 524 opposite to the exterior surface 525. The exterior surface 525 may receive powder 530 and the interior surface 524 may be applied with directed energy 555 and 556 from direct energy sources 550 and 551, respectively. The directed energy 555 and 556 may be applied to one or more transfer regions 532, 533 to disrupt an adhesion of the powder 530 positioned on the exterior surface 525. In some implementations, the powder dispensing unit 510 may be a roller having at least one stencil opening 549 to receive powder 530. The received powder 530 may then be transferred to the exterior surface 525 of the intermediate substrate 520 in the shape of the stencil opening 549. The powder 530 may then be processed while on the exterior surface 525 of the intermediate substrate 520 as described above. The intermediate substrate 520 may then transfer the patterned powder as powder layer 535 to the moving substrate 540.

Thus, one advantage of the various implementations of powder transfer systems disclosed herein is that powder may undergo minimum processing or processing only as necessary to facilitate adhesion and transfer of powder onto a target substrate. Another advantage is that powder does not accumulate in large volume and instead can be distributed along the surface of an intermediate substrate which may be scaled as needed for a desired powder mass flow rate. Moreover, since an intermediate substrate can be made sturdier and more robust than a target substrate, one advantage of the various implementations of powder transfer systems disclosed herein is that powder dispensed onto, and making direct contact with, an intermediate substrate can be less disruptive to the powder than powder being dispensed (e.g., from a hopper) onto a target substrate. Further, as the powder on the intermediate substrate is brought close to the target substrate by linear or rotational motion (e.g. rotation of the drum or belt), the transfer from the intermediate substrate can be accomplished via one of several means including, passive means such as gravity, contact transfer, flow of air/gas (the intermediate substrate would be porous to allow the gas to penetrate), acoustic energy (e.g., transducer driven vibration to dislodge the powder), changing the polarity of the electrostatic field, laser induced disruption of the powder adhesion to the intermediate substrate (e.g. laser-induced forward transfer, LIFT), and so on. In addition, since the intermediate substrate is more robust and can be tailored to suit the properties of the powder separate from the target substrate, the powder may be more easily made uniform and dispensed more reliably and uniformly from the intermediate substrate to the target substrate. Since the powder is transferred from the intermediate substrate to the target substrate by a directed energy, such as a laser, which is under digital control, the resulting transfer of the powder can be digitally controlled enabling the printing of arbitrary shapes and patterns of the powder on the target substrate.

### Method for Implementing Powder Transfer

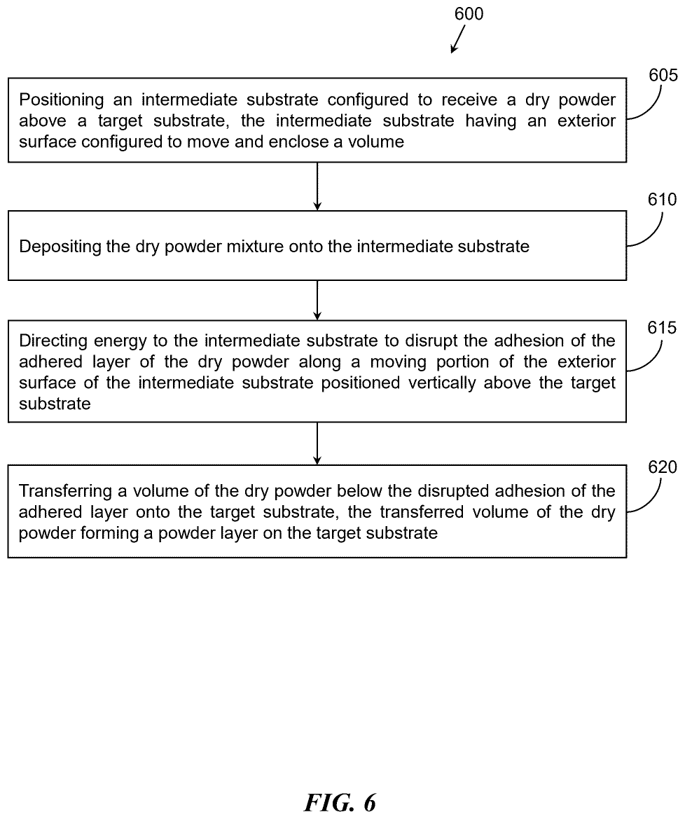

FIG. 6 illustrates an example flow chart showing a method of powder transfer from an intermediate surface to a target surface for facilitating controllable mass flow and uniform powder deposition, in accordance with one or more embodiments of the present disclosure. These exemplary methods are provided by way of example, as there are a variety of ways to carry out these methods. Each block shown in FIG. 6 represents one or more processes, methods, or subroutines, carried out in the exemplary method. FIGS. 1-4 and 5A-5B show example embodiments of carrying out the method of FIG. 6 for direct deposition of patterned powder and precise control of powder feature size, shape, and uniformity while improving powder deposition speed while minimizing additional processing and components that can reduce the flowability and cohesiveness of the dry powder during the process of powder deposition onto a target substrate. Each block shown in FIG. 6 represents one or more processes, methods, or subroutines, carried out in the exemplary method. The exemplary method may begin at block 605. Method 600 may be used independently or in combination with other methods or process for direct deposition of patterned powder and precise control of powder feature size, shape, and uniformity while improving powder deposition speed while minimizing additional processing and components that can reduce the flowability and cohesiveness of the dry powder during the process of powder deposition onto a target substrate. For explanatory purposes, the example process 600 is described herein with reference to the powder transfer system of FIGS. 1-4 and 5A-5B. Further for explanatory purposes, the blocks of the example process 600 are described herein as occurring in serial, or linearly. However, multiple blocks of the example process 600 may occur in parallel. In addition, the blocks of the example process 600 may be performed in a different order than the order shown and/or one or more of the blocks of the example process 600 may not be performed. Further, any or all blocks of example process 600 may further be combined and done in parallel, in order, or out of order.

In FIG. 6, the exemplary method 600 of a powder transfer system for direct deposition of patterned powder and precise control of powder feature size, shape, and uniformity while improving powder deposition speed, while minimizing additional processing and components that can reduce the flowability and cohesiveness of the dry powder, is shown. Method 600 begins at block 605. In block 605, the method includes positioning an intermediate substrate configured to receive a dry powder above a target substrate, the intermediate substrate having an exterior surface configured to move and enclose a volume. In one embodiment, the method may further comprise adjusting a surface uniformity of the dry powder prior to directing energy to the intermediate substrate. In block 610, the method includes depositing the dry powder onto the exterior surface of the intermediate substrate.

In block 615, the method includes directing energy to the intermediate substrate to disrupt the adhesion of the adhered layer of the dry powder along a moving portion of the exterior surface of the intermediate substrate positioned vertically above the target substrate. In one embodiment, the method may further include directing energy to disrupt the adhesion of the adhered layer of the dry powder from the exterior surface of the intermediate substrate such that the powder microstructure of the powder layer and the volume of dry powder is not changed. That is, the microstructure of the particles of the dry powder forming the volume of dry powder to be transferred is not changed by the directed energy applied to the volume of powder. Further, the microstructure of the particles of the dry powder forming the powder layer on the target substrate is not changed by directed energy applied to the volume of powder.

Moreover, in certain implementations, the method may further include applying the directed energy, from within the intermediate substrate, to an interior surface of the intermediate substrate beneath the dry powder to disrupt the adhesion of the adhered layer of the dry powder along the moving portion of the exterior surface of the intermediate substrate. Further, in many implementations, the dry powder adhered to the exterior surface of the intermediate substrate and the powder layer transferred to the target substrate have the same rheological properties.

In block 620, the method includes transferring a volume of the dry powder below the disrupted adhesion of the adhered layer onto the target substrate, the transferred volume of the dry powder forming a powder layer on the target substrate. In certain embodiments, the method may further include moving the target substrate in a longitudinal direction, horizontal to the volume enclosed, and directing energy to a length of the adhered layer such that the length of the powder layer transferred on the target substrate is substantially equal to the length of the adhered layer applied with the directed energy. In some implementations, in any of the steps above, the method may include conditioning the exterior surface of the intermediate substrate to improve at least one of a cohesiveness of the dry powder and an adhesion of the dry powder to the intermediate substrate. In one embodiment, the method may further include cleaning the exterior surface of the intermediate substrate to remove residual powder after the volume of the dry powder is transferred from the intermediate substrate to the target substrate. In certain embodiments, the method may further include roughening one or more surface regions of the exterior surface of the intermediate substrate, wherein the adhered layer of the dry powder is formed on at least one of the one or more roughened surface regions. In one implementation, the exterior surface of the intermediate substrate may be configured to have a roughened surface to increase friction between the deposited loose dry powder material and the exterior surface of the intermediate substrate to receive and hold the deposited material. For example, the intermediate substrate may include regions of roughened surfaces, patterns of roughened surfaces, or the entire exterior surface may be mechanically roughened to receive and hold dry powder material. Moreover, the roughened surface may include grooves, recesses, or other surface features having approximately the same dimensions of the deposited material (e.g., dry powder) in order to receive and hold the material deposited thereon. In some embodiments, the method may further include conditioning the exterior surface of the intermediate substrate using at least one of a film coating, spray coating, applying electric charge, or heating the exterior surface to improve at least one of a cohesiveness of the dry powder and an adhesion of the dry powder to the intermediate substrate.

It is noted that, although specific examples of processing steps for a 3D printing operation have been illustrated and discussed, the order of the processing steps could be changed, if desired, and/or additional processing steps could be added.

In the following, further features, characteristics, and advantages of the instant application will be described by means of items:

Item 1. An apparatus, comprising: an intermediate substrate configured to receive a dry powder, wherein an exterior surface of the intermediate substrate is configured to move and enclose a volume, the intermediate substrate positioned above a target substrate; a powder distribution device, the powder distribution device configured to distribute the dry powder on the exterior surface of the intermediate substrate; and a directed energy device, the directed energy device configured to apply energy to the intermediate substrate to disrupt the adhesion of an adhered layer of the dry powder along a moving portion of the exterior surface of the intermediate substrate positioned vertically above the target substrate; and wherein disruption of the adhesion of the adhered layer positioned on the exterior surface of the intermediate substrate facilitates transfer of a volume of the dry powder from the intermediate substrate to the target substrate thereby forming a powder layer on the target substrate.

Item 2. The apparatus of claim 1, wherein the directed energy device is configured such that the applied energy is less than a threshold energy that would fuse particles of the volume of the dry powder or damage 10%, by volume, the volume of dry powder.

Item 3. The apparatus of claim 2, further comprising a blade positioned at a distance from the powder distribution device, the powder distribution device further configured to distribute loose dry powder on the exterior surface of the intermediate substrate, and wherein the blade is configured to adjust the thickness of the dry powder.

Item 4. The apparatus of claim 2, further comprising a roller positioned at a distance from the powder distribution device, the powder distribution device further configured to distribute loose dry powder on the exterior surface of the intermediate substrate, and wherein the roller is configured to adjust the surface uniformity of the dry powder.

Item 5. The apparatus of claim 1, wherein the target substrate is configured to move in a longitudinal direction, horizontal to the volume enclosed, and wherein the length of the powder layer on the target substrate is substantially equal to the length of the adhered layer applied with energy from the directed energy device.

Item 6. The apparatus of claim 1, further comprising a cleaning device for cleaning the exterior surface of the intermediate substrate to remove residual powder after transferring the volume of the dry powder to the target substrate.

Item 7. The apparatus of claim 1, wherein the directed energy device comprises at least one of a solid-state laser, a gas laser, a semiconductor laser, a UV laser, and an infrared laser configured to irradiate the exterior surface of the intermediate substrate beneath the dry powder.

Item 8. The apparatus of claim 1, wherein the applied energy from the directed energy device is applied, from within the intermediate substrate, to an interior surface of the intermediate substrate beneath the dry powder to disrupt the adhesion of the adhered layer of the dry powder along the moving portion of the exterior surface of the intermediate substrate.

Item 9. The apparatus of claim 1, wherein the exterior surface of the intermediate substrate comprises one or more roughened surface regions, and wherein the adhered layer of the dry powder is formed on at least one of the one or more roughened surface regions.

Item 10. The apparatus of claim 1, further comprising a conditioning unit for conditioning the exterior surface of the intermediate substrate using at least one of a film coating, spray coating, applying electric charge, or heating the exterior surface to improve at least one of a cohesiveness of the dry powder and an adhesion of the dry powder to the intermediate substrate.

Item 11. The apparatus of claim 1, wherein the dry powder adhered to the exterior surface of the intermediate substrate and the powder layer transferred to the target substrate have the same rheological properties.

Item 12. A method, comprising: positioning an intermediate substrate configured to receive a dry powder above a target substrate, the intermediate substrate having an exterior surface configured to move and enclose a volume; depositing the dry powder onto the exterior surface of the intermediate substrate to form an adhered layer; directing energy to the intermediate substrate to disrupt the adhesion of the adhered layer along a moving portion of the exterior surface of the intermediate substrate positioned vertically above the target substrate; and transferring a volume of the dry powder of the adhered layer disrupted by the directed energy onto the target substrate, the transferred volume of the dry powder forming a powder layer on the target substrate.

Item 13. The method of claim 12, wherein directing energy to disrupt the adhesion of the adhered layer of the dry powder from the exterior surface of the intermediate substrate does not change the powder microstructure of the powder layer and the volume of dry powder.

Item 14. The method of claim 12, further comprising adjusting a surface uniformity of the dry powder prior to directing energy to the intermediate substrate.

Item 15. The method of claim 12, further comprising moving the target substrate in a longitudinal direction, horizontal to the volume enclosed, and directing energy to a length of the adhered layer such that the length of the powder layer transferred on the target substrate is substantially equal to the length of the adhered layer applied with the directed energy.

Item 16. The method of claim 12, further comprising cleaning the exterior surface of the intermediate substrate to remove residual powder after transferring the volume of the dry powder to the target substrate.

Item 17. The method of claim 12, further comprising applying the directed energy, from within the intermediate substrate, to an interior surface of the intermediate substrate beneath the dry powder to disrupt the adhesion of the adhered layer of the dry powder along the moving portion of the exterior surface of the intermediate substrate.

Item 18. The method of claim 12, further comprising roughening one or more surface regions of the exterior surface of the intermediate substrate, wherein the adhered layer of the dry powder is formed on at least one of the one or more roughened surface regions.

Item 19. The method of claim 12, further comprising conditioning the exterior surface of the intermediate substrate using at least one of a film coating, spray coating, applying electric charge, or heating the exterior surface to improve at least one of a cohesiveness of the dry powder and an adhesion of the dry powder to the intermediate substrate.

Item 20. The method of claim 12, further comprising configuring the directed energy device such that the powder layer on the target substrate and the volume of dry powder, applied with energy from the directed energy device, have the same powder microstructure.

### Definitions

A “feeder”, “hopper”, or “funnel” as used herein includes, but is not limited to, any container or structure having one or more openings for holding and dispensing material.

A “dry powder”, “dry powder material”, “dry powder electrode”, “dry powder anode”, “dry powder cathode”, “loose powder”, “loose dry powder”, “particle”, “particulate”, “powder material”, or “powder layer” as used herein includes, but is not limited to, any particle or particulate of a dry powder material, dry powder materials, or dry powder compositions that may be altered (e.g., mixed with one or more particles, binders, solvents, conductive additives, or active anode or cathode materials) and/or conditioned through one or more conditioning means to improve flowability, cohesion, and handleability, and are used herein interchangeably.

A “agitation”, “actuation”, or “vibration” as used herein includes, but is not limited to, any application of mechanical energy to a surface that can emit longitudinal, radial, or transverse waves to disrupt or displace powder or material resting on the surface or impart energy to the powder or material to effectuate motion of the powder or material.

A “powder transfer system,” “powder transfer device,” “powder transfer apparatus,” “powder distribution device,” “powder distribution system,” or “powder distribution apparatus” as used herein, includes, but is not limited to, any system or apparatus that facilitates transfer of material from a moving intermediate surface/substrate onto a moving target surface/substrate including or excluding a container or structure having one or more openings for holding and dispensing material.

A “rotating body,” or “moving body,” as used herein, includes, but is not limited to, any device configured to facilitate movement of a substrate (or surface) to store, carry, and transport material deposited thereon onto a moving target substrate. As an example, a rotating body can include one or more rollers/rods coupled to one or more bendable or rotatable substrates. The substrate may be a belt, a roll, a flexible substrate, a continuous substrate, a segmented substrate, or a transparent substrate. The rotating body can have a plurality of distinct or segmented surfaces or substrates for receiving materials (e.g., a cog or a spline) whereby the substrate rotates about an axis to facilitate transport material deposited thereon. The moving target substrate may be located at a distance away from a powder distribution or powder deposition system used to deposit the material onto the substrate. The term “intermediate surface” or “intermediate substrate” and “rotating body” or “moving body” may be used interchangeably in the present disclosure and may include moving surfaces or moving structures to an inverted position to facilitate transport of material deposited thereon.

A “stencil,” or “shape,” as used herein, includes, but is not limited to, patterned powder taking the shape of any letter/character shape (e.g., T, U, H, L, I, or other character shapes, etc.,), any polygonal shape (e.g., a strip, a square, triangle, rectangle, etc.,), or any curved or piece-wise rectilinear shape (e.g., a star shape, etc.,). The powder may be patterned at any stage of processing using any device/stencil as described herein, including the initial stage of depositing a patterned powder on the intermediate substrate using a stencil to pattern the powder deposited, for example, patterning the powder on the intermediate substrate using a conditioning device/directed energy source to pattern the powder, and transferring a patterned powder by using a directed energy source to pattern the powder transferred to the target substate.

### Definitions and Other Embodiments

In another embodiment, the described methods and/or their equivalents may be implemented with computer executable instructions. Thus, in one embodiment, a non-transitory computer readable/storage medium is configured with stored computer executable instructions of an algorithm/executable application that when executed by a machine(s) cause the machine(s) (and/or associated components) to perform the method. Example machines include but are not limited to a processor, a computer, a server operating in a cloud computing system, a server configured in a Software as a Service (SaaS) architecture, a smart phone, and so on). In one embodiment, a computing device is implemented with one or more executable algorithms that are configured to perform any of the disclosed methods.

In one or more embodiments, the disclosed methods or their equivalents are performed by either: computer hardware configured to perform the method; or computer instructions embodied in a module stored in a non-transitory computer-readable medium where the instructions are configured as an executable algorithm configured to perform the method when executed by at least a processor of a computing device.

While for purposes of simplicity of explanation, the illustrated methodologies in the figures are shown and described as a series of blocks of an algorithm, it is to be appreciated that the methodologies are not limited by the order of the blocks. Some blocks can occur in different orders and/or concurrently with other blocks from those shown and described. Moreover, less than all the illustrated blocks may be used to implement an example methodology. Blocks may be combined or separated into multiple actions/components. Furthermore, additional, and/or alternative methodologies can employ additional actions that are not illustrated in blocks. The methods described herein are limited to statutory subject matter under 35 U.S.C. § 101.

The following includes definitions of selected terms employed herein. The definitions include various examples and/or forms of components that fall within the scope of a term and that may be used for implementation. The examples are not intended to be limiting. Both singular and plural forms of terms may be within the definitions.

Unless otherwise stated, all measurements, values, ratings, positions, magnitudes, sizes, and other specifications that are set forth in this specification, including in the claims that follow, are approximate, not exact. They are intended to have a reasonable range that is consistent with the functions to which they relate and with what is customary in the art to which they pertain.

The term “adjacent”, “within a proximity”, “a vicinity”, “within a vicinity”, “within a predetermined distance”, “predetermined width”, “predetermined height”, “predetermined length” and the like may be defined between about 0.01 centimeter and about 0.5 meters. The term “coupled” is defined as connected, whether directly or indirectly through intervening components, and is not necessarily limited to physical connections. The connection may be such that the objects are permanently connected or releasably connected. The term “substantially” is defined to be essentially conforming to the particular dimension, shape, or other feature that the term modifies, such that the component need not be exact. For example, “substantially cylindrical” means that the object resembles a cylinder, but may have one or more deviations from a true cylinder. The term “comprising,” when utilized, means “including, but not necessarily limited to”; it specifically indicates open-ended inclusion or membership in the so-described combination, group, series, and the like.

The term “a predefined” or “a predetermined” when referring to length, width, height, or distances may be defined as between about 0.01 centimeter and about 0.5 meters.

Phrases such as an aspect, the aspect, another aspect, some aspects, one or more aspects, an implementation, the implementation, another implementation, some implementations, one or more implementations, an embodiment, the embodiment, another embodiment, some embodiments, one or more embodiments, a configuration, the configuration, another configuration, some configurations, one or more configurations, the present disclosure, the disclosure, the present disclosure, other variations thereof and alike are for convenience and do not imply that a disclosure relating to such phrase(s) is essential to the present disclosure or that such disclosure applies to all configurations of the present disclosure. A disclosure relating to such phrase(s) may apply to all configurations, or one or more configurations. A disclosure relating to such phrase(s) may provide one or more examples. A phrase such as an aspect or some aspects may refer to one or more aspects and vice versa, and this applies similarly to other foregoing phrases.

The word “exemplary” is used herein to mean “serving as an example, instance, or illustration.” Any embodiment described herein as “exemplary” or as an “example” is not necessarily to be construed as preferred or advantageous over other embodiments. Furthermore, to the extent that the term “include”, “have”, or the like is used in the description or the claims, such term is intended to be inclusive in a manner similar to the term “comprise” as “comprise” is interpreted when employed as a transitional word in a claim.

All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112, sixth paragraph, unless the element is expressly recited using the phrase “means for” or, in the case of a method claim, the element is recited using the phrase “step for.”

The previous description of the disclosed embodiments is provided to enable a person skilled in the art to make or use the disclosed embodiments. Various modifications to these embodiments will be readily apparent to those skilled in the art, and the principles defined herein may be applied to other embodiments without departing from the scope of the disclosure. Thus, the present disclosure is not intended to be limited to the embodiments shown herein but is to be accorded the widest scope possible consistent with the principles and novel features as defined by the following claims.

References to “one embodiment”, “an embodiment”, “one example”, “an example”, and so on, indicate that the embodiment(s) or example(s) so described may include a particular feature, structure, characteristic, property, element, or limitation, but that not every embodiment or example necessarily includes that particular feature, structure, characteristic, property, element or limitation. Furthermore, repeated use of the phrase “in one embodiment” does not necessarily refer to the same embodiment, though it may. The embodiments shown and described above are only examples. Many details are often found in the art such as the other features of an image device. Therefore, many such details are neither shown nor described. Even though numerous characteristics and advantages of the present technology have been set forth in the foregoing description, together with details of the structure and function of the present disclosure, the disclosure is illustrative only, and changes may be made in the detail, especially in matters of shape, size, and arrangement of the parts within the principles of the present disclosure, up to and including the full extent established by the broad general meaning of the terms used in the claims. It will therefore be appreciated that the embodiments described above may be modified within the scope of the claims.

An “operable connection”, or a connection by which entities are “operably connected”, is one in which signals, physical communications, and/or logical communications may be sent and/or received. An operable connection may include a physical interface, an electrical interface, and/or a data interface. An operable connection may include differing combinations of interfaces and/or connections sufficient to allow operable control. For example, two entities can be operably connected to communicate signals to each other directly or through one or more intermediate entities (e.g., processor, operating system, logic, non-transitory computer-readable medium). Logical and/or physical communication channels can be used to create an operable connection.

“User”, as used herein, includes but is not limited to one or more persons, computers or other devices, or combinations of these.

While the disclosed embodiments have been illustrated and described in considerable detail, it is not the intention to restrict or in any way limit the scope of the appended claims to such detail. It is, of course, not possible to describe every conceivable combination of components or methodologies for purposes of describing the various aspects of the subject matter. Therefore, the disclosure is not limited to the specific details or the illustrative examples shown and described. Thus, this disclosure is intended to embrace alterations, modifications, and variations that fall within the scope of the appended claims, which satisfy the statutory subject matter requirements of 35 U.S.C. § 101.

To the extent that the term “includes” or “including” is employed in the detailed description or the claims, it is intended to be inclusive in a manner similar to the term “comprising” as that term is interpreted when employed as a transitional word in a claim.

To the extent that the term “or” is used in the detailed description or claims (e.g., A or B) it is intended to mean “A or B or both”. When the applicants intend to indicate “only A or B but not both” then the phrase “only A or B but not both” will be used. Thus, use of the term “or” herein is the inclusive, and not the exclusive use.

What is claimed is:

1. An apparatus, comprising:
an intermediate substrate configured to receive a dry powder, wherein an exterior surface of the intermediate substrate is configured to move and enclose a volume, the intermediate substrate positioned above a target substrate; and
a powder distribution device, the powder distribution device configured to distribute the dry powder on the exterior surface of the intermediate substrate; and
a directed energy device, the directed energy device configured to apply energy to the intermediate substrate to disrupt the adhesion of an adhered layer of the dry powder along a moving portion of the exterior surface of the intermediate substrate positioned vertically above the target substrate; and
wherein disruption of the adhesion of the adhered layer positioned on the exterior surface of the intermediate substrate facilitates transfer of a volume of the dry powder from the intermediate substrate to the target substrate thereby forming a powder layer on the target substrate.

2. The apparatus of claim 1, wherein the directed energy device is configured such that the applied energy is less than a threshold energy that would fuse particles of the volume of the dry powder or damage 10%, by volume, the volume of dry powder.

3. The apparatus of claim 2, further comprising a blade positioned at a distance from the powder distribution device, the powder distribution device further configured to distribute loose dry powder on the exterior surface of the intermediate substrate, and wherein the blade is configured to adjust the thickness of the dry powder.

4. The apparatus of claim 2, further comprising a roller positioned at a distance from the powder distribution device, the powder distribution device further configured to distribute loose dry powder on the exterior surface of the intermediate substrate, and wherein the roller is configured to adjust the surface uniformity of the dry powder.

5. The apparatus of claim 1, wherein the target substrate is configured to move in a longitudinal direction, horizontal to the volume enclosed, and wherein the length of the powder layer on the target substrate is substantially equal to the length of the adhered layer applied with energy from the directed energy device.

6. The apparatus of claim 1, further comprising a cleaning device for cleaning the exterior surface of the intermediate substrate to remove residual powder after transferring the volume of the dry powder to the target substrate.

7. The apparatus of claim 1, wherein the directed energy device comprises at least one of a solid-state laser, a gas laser, a semiconductor laser, a UV laser, and an infrared laser configured to irradiate the exterior surface of the intermediate substrate beneath the dry powder.

8. The apparatus of claim 1, wherein the applied energy from the directed energy device is applied, from within the intermediate substrate, to an interior surface of the intermediate substrate beneath the dry powder to disrupt the adhesion of the adhered layer of the dry powder along the moving portion of the exterior surface of the intermediate substrate.

9. The apparatus of claim 1, wherein the exterior surface of the intermediate substrate comprises one or more roughened surface regions, and wherein the adhered layer of the dry powder is formed on at least one of the one or more roughened surface regions.

10. The apparatus of claim 1, further comprising a conditioning unit for conditioning the exterior surface of the intermediate substrate using at least one of a film coating, spray coating, applying electric charge, or heating the exterior surface to improve at least one of a cohesiveness of the dry powder and an adhesion of the dry powder to the intermediate substrate.

11. The apparatus of claim 1, wherein the dry powder adhered to the exterior surface of the intermediate substrate and the powder layer transferred to the target substrate have the same rheological properties.

12. A method, comprising:
positioning an intermediate substrate configured to receive a dry powder above a target substrate, the intermediate substrate having an exterior surface configured to move and enclose a volume;
depositing the dry powder onto the exterior surface of the intermediate substrate to form an adhered layer;
directing energy to the intermediate substrate to disrupt the adhesion of the adhered layer along a moving portion of the exterior surface of the intermediate substrate positioned vertically above the target substrate; and
transferring a volume of the dry powder of the adhered layer disrupted by the directed energy onto the target substrate, the transferred volume of the dry powder forming a powder layer on the target substrate.

13. The method of claim 12, wherein directing energy to disrupt the adhesion of the adhered layer of the dry powder from the exterior surface of the intermediate substrate does not change the powder microstructure of the powder layer and the volume of dry powder.

14. The method of claim 12, further comprising adjusting a surface uniformity of the dry powder prior to directing energy to the intermediate substrate.

15. The method of claim 12, further comprising moving the target substrate in a longitudinal direction, horizontal to the volume enclosed, and directing energy to a length of the adhered layer such that the length of the powder layer transferred on the target substrate is substantially equal to the length of the adhered layer applied with the directed energy.

16. The method of claim 12, further comprising cleaning the exterior surface of the intermediate substrate to remove residual powder after transferring the volume of the dry powder to the target substrate.

17. The method of claim 12, further comprising applying the directed energy, from within the intermediate substrate, to an interior surface of the intermediate substrate beneath the dry powder to disrupt the adhesion of the adhered layer of the dry powder along the moving portion of the exterior surface of the intermediate substrate.

18. The method of claim 12, further comprising roughening one or more surface regions of the exterior surface of the intermediate substrate, wherein the adhered layer of the dry powder is formed on at least one of the one or more roughened surface regions.

19. The method of claim 12, further comprising conditioning the exterior surface of the intermediate substrate using at least one of a film coating, spray coating, applying electric charge, or heating the exterior surface to improve at least one of a cohesiveness of the dry powder and an adhesion of the dry powder to the intermediate substrate.

20. The method of claim 12, further comprising configuring the directed energy device such that the powder layer on the target substrate and the volume of dry powder, applied with energy from the directed energy device, have the same powder microstructure.
